(19) United States
(12) Patent Application Publication
(10) Pub. No.: US 2025/0374327 A1
(43) Pub. Date: Dec. 4, 2025

(54) UNIFIED TRANSMISSION CONFIGURATION INDICATOR STATES FOR RANDOM ACCESS PROCEDURES

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/874,272

(22) PCT Filed: Aug. 26, 2022
(86) PCT No.: PCT/CN2022/115032

§ 371 Date: Dec. 12, 2024

(51) Int. Cl. H04W 74/0833; H04B 7/06; H04W 72/23

(52) U.S. Cl. CPC H04W 74/0833; H04B 7/06952; H04W 72/23

(57) ABSTRACT

Various aspects of the present disclosure generally relate to wireless communication. In some aspects, a mobile station may receive an indication of a unified transmission configuration indicator (TCI) state. The mobile station may transmit an uplink transmission, scheduled by downlink control information scrambled with a temporary cell radio network temporary identifier, using a TCI state other than the unified TCI state. Numerous other aspects are described.

### FIELD OF THE DISCLOSURE

Aspects of the present disclosure generally relate to wireless communication and to techniques and apparatuses for applying unified transmission configuration indicator states for random access procedures.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to an apparatus for wireless communication at a mobile station. The apparatus may include a memory and one or more processors coupled to the memory. The one or more processors, based at least in part on information stored in the memory, may be configured to receive an indication of a unified transmission configuration indicator (TCI) state. The one or more processors, based at least in part on information stored in the memory, may be configured to transmit an uplink transmission, scheduled by downlink control information (DCI) scrambled with a temporary cell radio network temporary identifier (TC-RNTI), using a TCI state other than the unified TCI state.

Some aspects described herein relate to an apparatus for wireless communication at a network entity. The apparatus may include a memory and one or more processors coupled to the memory. The one or more processors, based at least in part on information stored in the memory, may be configured to transmit an indication of a unified TCI state. The one or more processors, based at least in part on information stored in the memory, may be configured to transmit a downlink transmission, scheduled by DCI scrambled with a TC-RNTI, using a TCI state other than the unified TCI state.

Some aspects described herein relate to an apparatus for wireless communication at a mobile station. The apparatus may include a memory and one or more processors coupled to the memory. The one or more processors, based at least in part on information stored in the memory, may be configured to receive an indication of a unified TCI state. The one or more processors, based at least in part on information stored in the memory, may be configured to transmit an uplink transmission, scheduled by DCI scrambled with a TC-RNTI, using the unified TCI state.

Some aspects described herein relate to an apparatus for wireless communication at a network entity. The apparatus may include a memory and one or more processors coupled to the memory. The one or more processors, based at least in part on information stored in the memory, may be configured to transmit an indication of a unified TCI state. The one or more processors, based at least in part on information stored in the memory, may be configured to transmit a downlink transmission, scheduled by DCI scrambled with a TC-RNTI, using the unified TCI state.

Some aspects described herein relate to an apparatus for wireless communication at a mobile station. The apparatus may include a memory and one or more processors coupled to the memory. The one or more processors, based at least in part on information stored in the memory, may be configured to receive an indication of a unified TCI state. The one or more processors, based at least in part on information stored in the memory, may be configured to receive a control message triggering a random access procedure. The one or more processors, based at least in part on information stored in the memory, may be configured to transmit an uplink transmission, associated with the random access procedure, using a TCI state associated with the control message.

Some aspects described herein relate to an apparatus for wireless communication at a network entity. The apparatus may include a memory and one or more processors coupled to the memory. The one or more processors, based at least in part on information stored in the memory, may be configured to transmit an indication of a unified TCI state. The one or more processors, based at least in part on information stored in the memory, may be configured to transmit a control message triggering a random access procedure. The one or more processors, based at least in part on information stored in the memory, may be configured to transmit a downlink transmission, associated with the random access procedure, using a TCI state associated with the control message.

Some aspects described herein relate to a method of wireless communication performed by a mobile station. The method may include receiving, by the mobile station, an indication of a unified TCI state. The method may include transmitting, by the mobile station, an uplink transmission, scheduled by DCI scrambled with a TC-RNTI, using a TCI state other than the unified TCI state.

Some aspects described herein relate to a method of wireless communication performed by a network entity. The method may include transmitting, by the network entity, an indication of a unified TCI state. The method may include transmitting, by the network entity, a downlink transmission, scheduled by DCI scrambled with a TC-RNTI, using a TCI state other than the unified TCI state.

Some aspects described herein relate to a method of wireless communication performed by a mobile station. The method may include receiving, by the mobile station, an indication of a unified TCI state. The method may include transmitting, by the mobile station, an uplink transmission, scheduled by DCI scrambled with a TC-RNTI, using the unified TCI state.

Some aspects described herein relate to a method of wireless communication performed by a network entity. The method may include transmitting, by the network entity, an indication of a unified TCI state. The method may include transmitting, by the network entity, a downlink transmission, scheduled by DCI scrambled with a TC-RNTI, using the unified TCI state.

Some aspects described herein relate to a method of wireless communication performed by a mobile station. The method may include receiving, by the mobile station, an indication of a unified TCI state. The method may include receiving, by the mobile station, a control message triggering a random access procedure. The method may include transmitting, by the mobile station, an uplink transmission, associated with the random access procedure, using a TCI state associated with the control message.

Some aspects described herein relate to a method of wireless communication performed by a network entity. The method may include transmitting, by the network entity, an indication of a unified TCI state. The method may include transmitting, by the network entity, a control message triggering a random access procedure. The method may include transmitting, by the network entity, a downlink transmission, associated with the random access procedure, using a TCI state associated with the control message.

Some aspects described herein relate to a non-transitory computer-readable medium that stores a set of instructions for wireless communication by a mobile station. The set of instructions, when executed by one or more processors of the mobile station, may cause the mobile station to receive an indication of a unified TCI state. The set of instructions, when executed by one or more processors of the mobile station, may cause the mobile station to transmit an uplink transmission, scheduled by DCI scrambled with a TC-RNTI, using a TCI state other than the unified TCI state.

Some aspects described herein relate to a non-transitory computer-readable medium that stores a set of instructions for wireless communication by a network entity. The set of instructions, when executed by one or more processors of the network entity, may cause the network entity to transmit an indication of a unified TCI state. The set of instructions, when executed by one or more processors of the network entity, may cause the network entity to transmit a downlink transmission, scheduled by DCI scrambled with a TC-RNTI, using a TCI state other than the unified TCI state.

Some aspects described herein relate to a non-transitory computer-readable medium that stores a set of instructions for wireless communication by a mobile station. The set of instructions, when executed by one or more processors of the mobile station, may cause the mobile station to receive an indication of a unified TCI state. The set of instructions, when executed by one or more processors of the mobile station, may cause the mobile station to transmit an uplink transmission, scheduled by DCI scrambled with a TC-RNTI, using the unified TCI state.

Some aspects described herein relate to a non-transitory computer-readable medium that stores a set of instructions for wireless communication by a network entity. The set of instructions, when executed by one or more processors of the network entity, may cause the network entity to transmit an indication of a unified TCI state. The set of instructions, when executed by one or more processors of the network entity, may cause the network entity to transmit a downlink transmission, scheduled by DCI scrambled with a TC-RNTI, using the unified TCI state.

Some aspects described herein relate to a non-transitory computer-readable medium that stores a set of instructions for wireless communication by a mobile station. The set of instructions, when executed by one or more processors of the mobile station, may cause the mobile station to receive an indication of a unified TCI state. The set of instructions, when executed by one or more processors of the mobile station, may cause the mobile station to receive a control message triggering a random access procedure. The set of instructions, when executed by one or more processors of the mobile station, may cause the mobile station to transmit an uplink transmission, associated with the random access procedure, using a TCI state associated with the control message.

Some aspects described herein relate to a non-transitory computer-readable medium that stores a set of instructions for wireless communication by a network entity. The set of instructions, when executed by one or more processors of the network entity, may cause the network entity to transmit an indication of a unified TCI state. The set of instructions, when executed by one or more processors of the network entity, may cause the network entity to transmit a control message triggering a random access procedure. The set of instructions, when executed by one or more processors of the network entity, may cause the network entity to transmit a downlink transmission, associated with the random access procedure, using a TCI state associated with the control message.

Some aspects described herein relate to an apparatus for wireless communication. The apparatus may include means for receiving an indication of a unified TCI state. The apparatus may include means for transmitting an uplink transmission, scheduled by DCI scrambled with a TC-RNTI, using a TCI state other than the unified TCI state.

Some aspects described herein relate to an apparatus for wireless communication. The apparatus may include means for transmitting an indication of a unified TCI state. The apparatus may include means for transmitting a downlink transmission, scheduled by DCI scrambled with a TC-RNTI, using a TCI state other than the unified TCI state.

Some aspects described herein relate to an apparatus for wireless communication. The apparatus may include means for receiving an indication of a unified TCI state. The apparatus may include means for transmitting an uplink transmission, scheduled by DCI scrambled with a TC-RNTI, using the unified TCI state.

Some aspects described herein relate to an apparatus for wireless communication. The apparatus may include means for transmitting an indication of a unified TCI state. The apparatus may include means for transmitting a downlink transmission, scheduled by DCI scrambled with a TC-RNTI, using the unified TCI state.

Some aspects described herein relate to an apparatus for wireless communication. The apparatus may include means for receiving an indication of a unified TCI state. The apparatus may include means for receiving a control message triggering a random access procedure. The apparatus may include means for transmitting an uplink transmission, associated with the random access procedure, using a TCI state associated with the control message.

Some aspects described herein relate to an apparatus for wireless communication. The apparatus may include means for transmitting an indication of a unified TCI state. The apparatus may include means for transmitting a control message triggering a random access procedure. The apparatus may include means for transmitting a downlink transmission, associated with the random access procedure, using a TCI state associated with the control message.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of using beams for communications between a network node and a UE, in accordance with the present disclosure.

FIG. 5 is a diagram illustrating an example associated with refraining from using unified transmission configuration indicator (TCI) states during a random access procedure, in accordance with the present disclosure.

FIG. 6 is a diagram illustrating an example associated with using unified TCI states during a random access procedure, in accordance with the present disclosure.

FIG. 7 is a diagram illustrating an example associated with using a TCI state from a downlink control information order during a random access procedure, in accordance with the present disclosure.

FIGS. 8, 9, 10, 11, 12, and 13 are diagrams illustrating example processes associated with applying TCI states during a random access procedure, in accordance with the present disclosure.

FIGS. 14 and 15 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

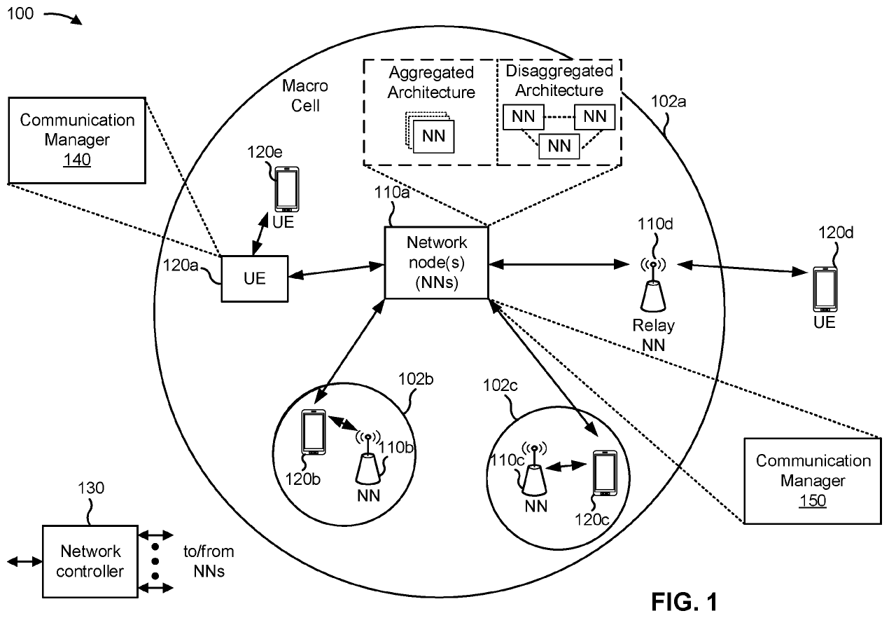

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a mobile station (e.g., the UE 120) may include a communication manager 140. As described in more detail elsewhere herein, the communication manager 140 may receive an indication of a unified transmission configuration indicator (TCI) state and may transmit an uplink transmission, scheduled by downlink control information (DCI) scrambled with a temporary cell radio network temporary identifier (TC-RNTI), using a TCI state other than the unified TCI state. Alternatively, the communication manager 140 may receive an indication of a TCI state and may transmit an uplink transmission, scheduled by DCI scrambled with a TC-RNTI, using the unified TCI state. Additionally, or alternatively, the communication manager 140 may receive an indication of a unified TCI state, may receive a control message triggering a random access procedure, and may transmit an uplink transmission, associated with the random access procedure, using a TCI state associated with the control message. Additionally, or alternatively, the communication manager 140 may perform one or more other operations described herein.

In some aspects, a network entity (e.g., the network node 110) may include a communication manager 150. As described in more detail elsewhere herein, the communication manager 150 may transmit an indication of a unified TCI state and may transmit a downlink transmission, scheduled by DCI scrambled with a TC-RNTI, using a TCI state other than the unified TCI state. Alternatively, the communication manager 150 may transmit an indication of a unified TCI state and may transmit a downlink transmission, scheduled by DCI scrambled with a TC-RNTI, using the unified TCI state. Additionally, or alternatively, the communication manager 150 may transmit an indication of a unified TCI state, may transmit a control message triggering a random access procedure, and may transmit a downlink transmission, associated with the random access procedure, using a TCI state associated with the control message. Additionally, or alternatively, the communication manager 150 may perform one or more other operations described herein.

As indicated above, FIG. 1 is provided as an example. Other examples may differ from what is described with regard to FIG. 1.

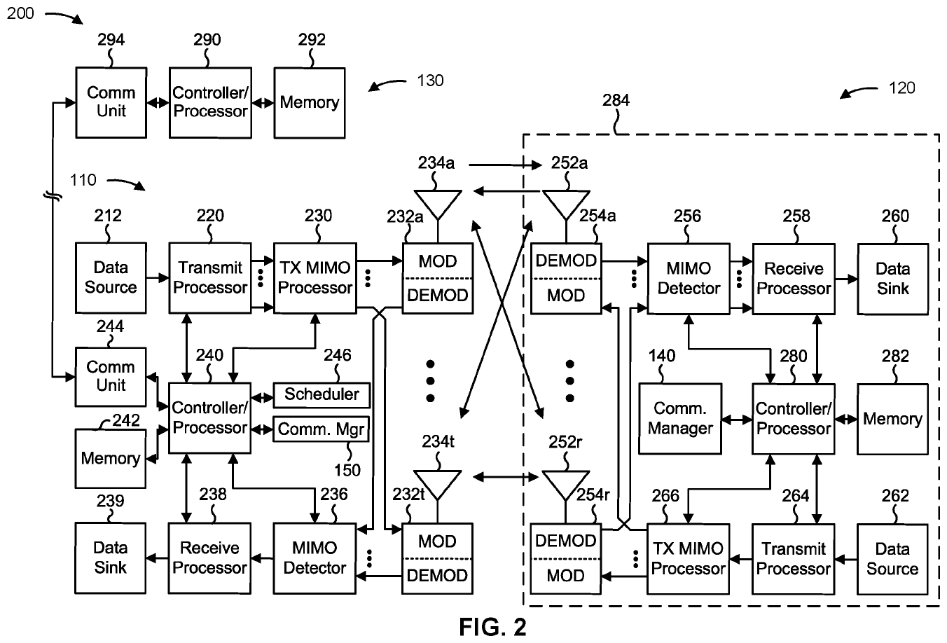

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

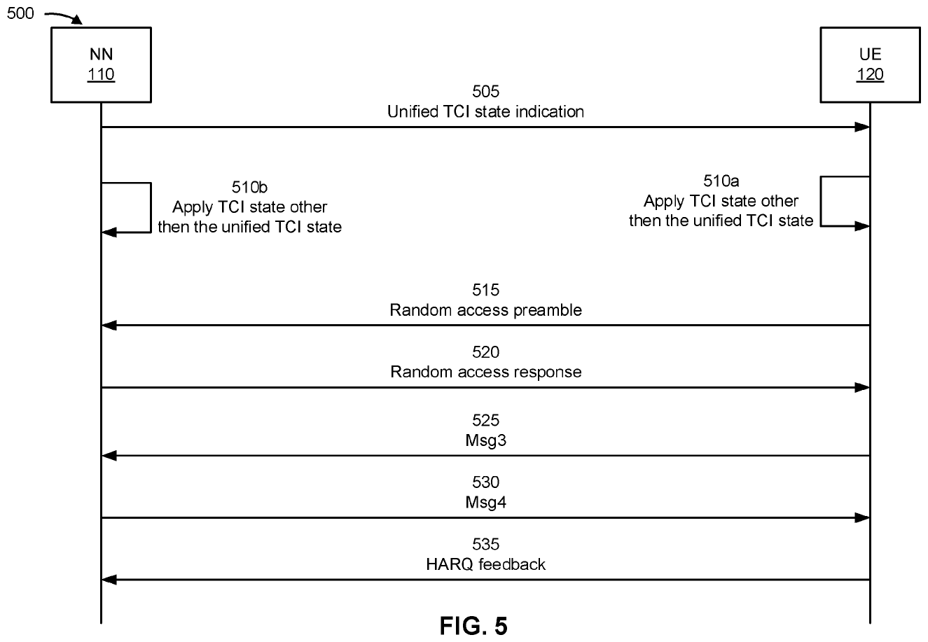

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-15).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-15).

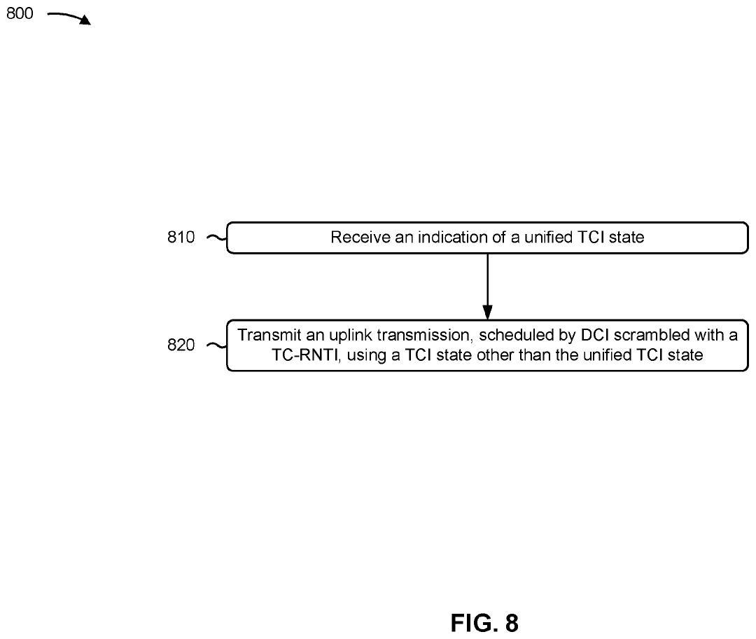

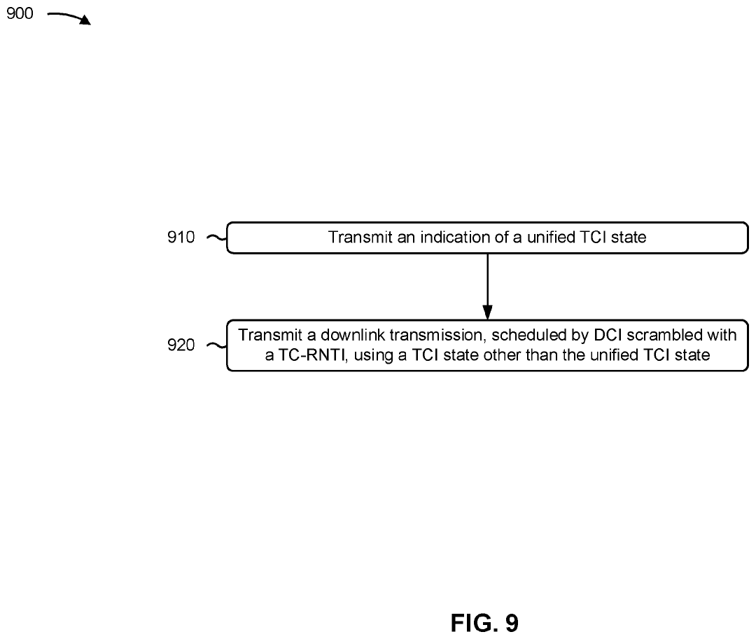

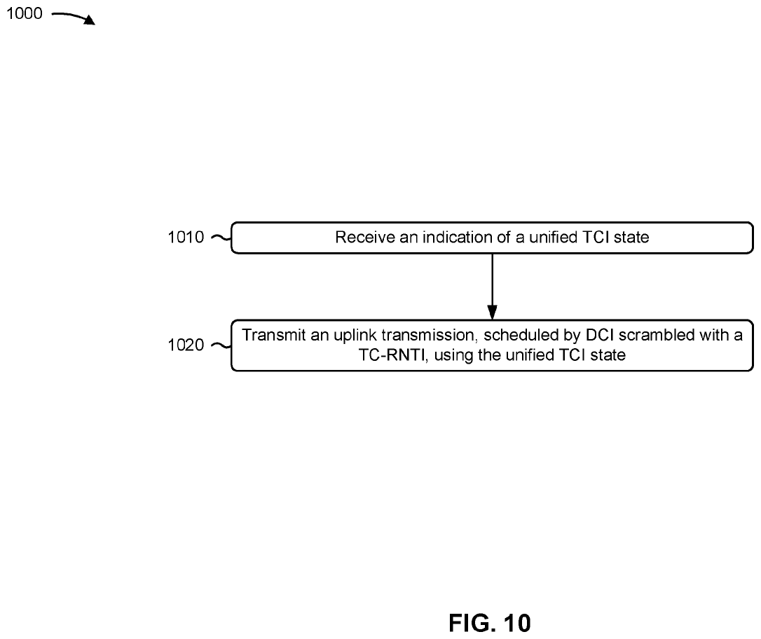

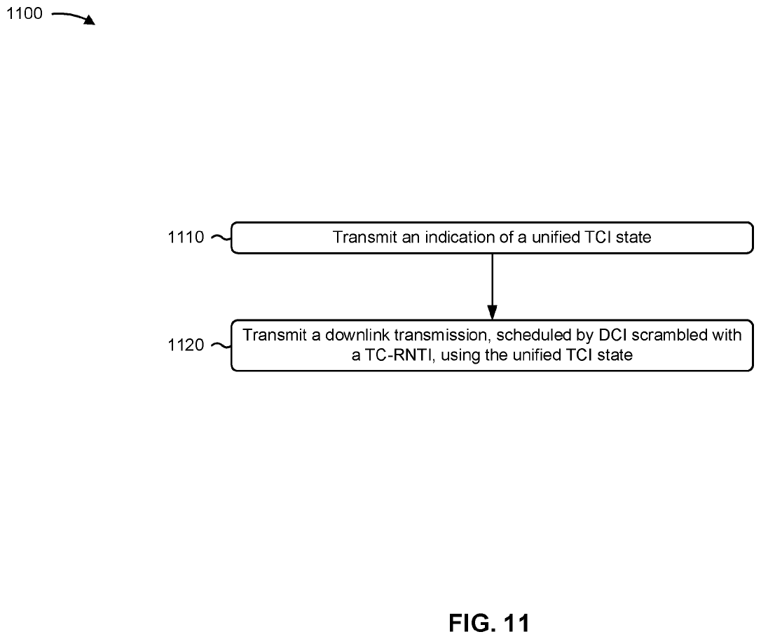

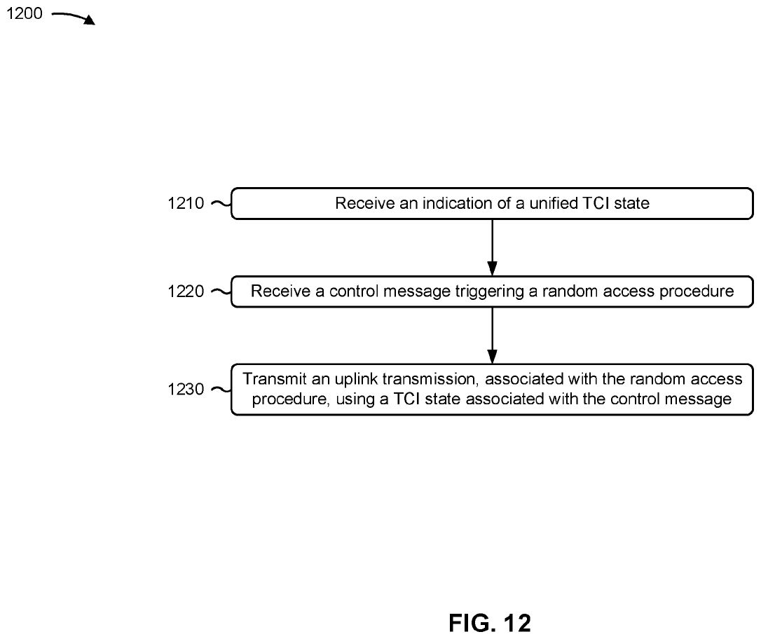

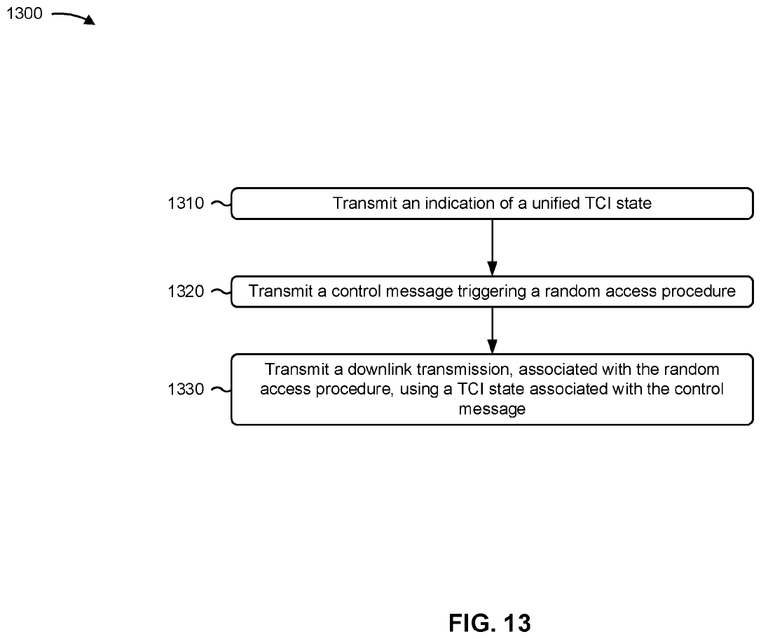

The controller/processor 240 of the network node 110, the controller/processor 280 of the UE 120, and/or any other component(s) of FIG. 2 may perform one or more techniques associated with applying unified TCI states for random access procedures, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, process 1000 of FIG. 10, process 1100 of FIG. 11, process 1200 of FIG. 12, process 1300 of FIG. 13, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, process 1000 of FIG. 10, process 1100 of FIG. 11, process 1200 of FIG. 12, process 1300 of FIG. 13, and/or other processes as described herein. In some examples, executing instructions may include running the instructions, converting the instructions, compiling the instructions, and/or interpreting the instructions, among other examples. In some aspects, the mobile station described herein is the UE 120, is included in the UE 120, or includes one or more components of the UE 120 shown in FIG. 2.

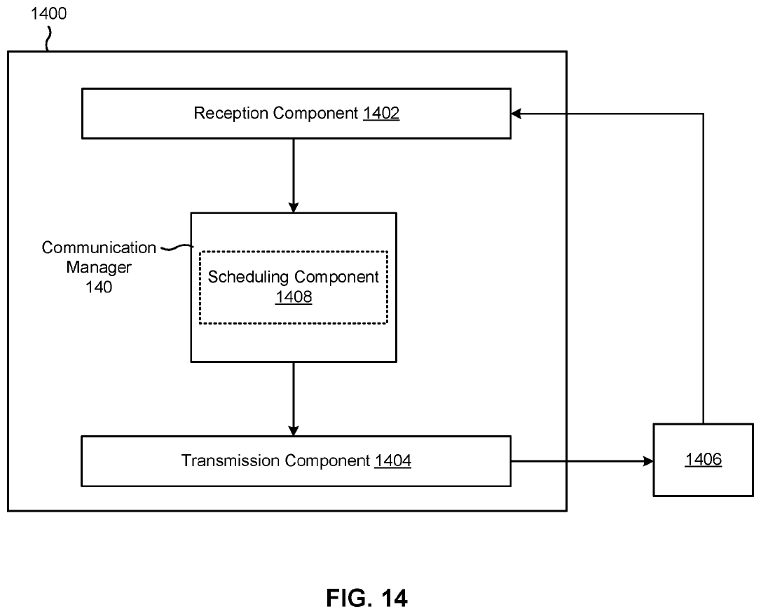

In some aspects, a mobile station (e.g., the UE 120 and/or apparatus 1400 of FIG. 14) may include means for receiving an indication of a unified TCI state and/or means for transmitting an uplink transmission, scheduled by DCI scrambled with a TC-RNTI, using a TCI state other than the unified TCI state. Alternatively, the mobile station may include means for receiving an indication of a unified TCI state and/or means for transmitting an uplink transmission, scheduled by DCI scrambled with a TC-RNTI, using the unified TCI state. Additionally, or alternatively, the mobile station may include means for receiving an indication of a unified TCI state; means for receiving a control message triggering a random access procedure; and/or means for transmitting an uplink transmission, associated with the random access procedure, using a TCI state associated with the control message. In some aspects, the means for the mobile station to perform operations described herein may include, for example, one or more of communication manager 140, antenna 252, modem 254, MIMO detector 256, receive processor 258, transmit processor 264, TX MIMO processor 266, controller/processor 280, or memory 282.

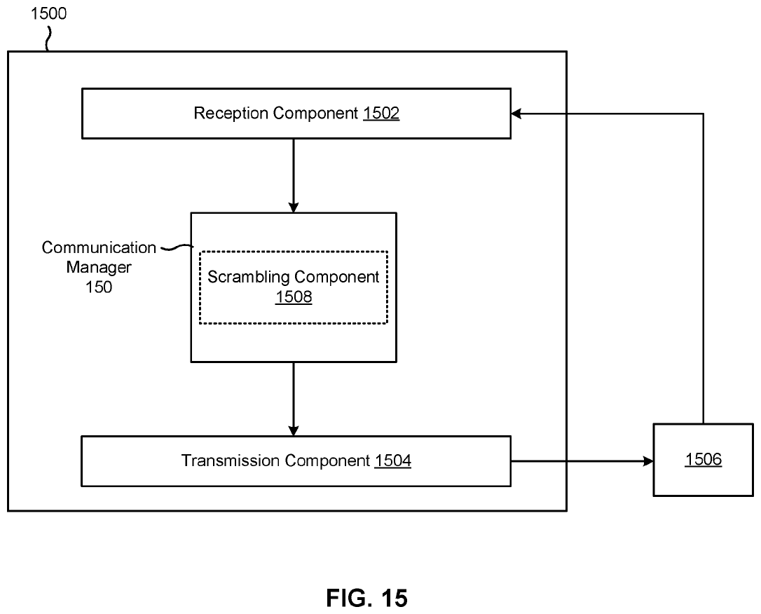

In some aspects, a network entity (e.g., the network node 110 and/or apparatus 1500 of FIG. 15) may include means for transmitting an indication of a unified TCI state and/or means for transmitting a downlink transmission, scheduled by DCI scrambled with a TC-RNTI, using a TCI state other than the unified TCI state. Alternatively, the network entity may include means for transmitting an indication of a unified TCI state and/or means for transmitting a downlink transmission, scheduled by DCI scrambled with a TC-RNTI, using the unified TCI state. Additionally, or alternatively, the network entity may include means for transmitting an indication of a unified TCI state; means for transmitting a control message triggering a random access procedure; and/or means for transmitting a downlink transmission, associated with the random access procedure, using a TCI state associated with the control message. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

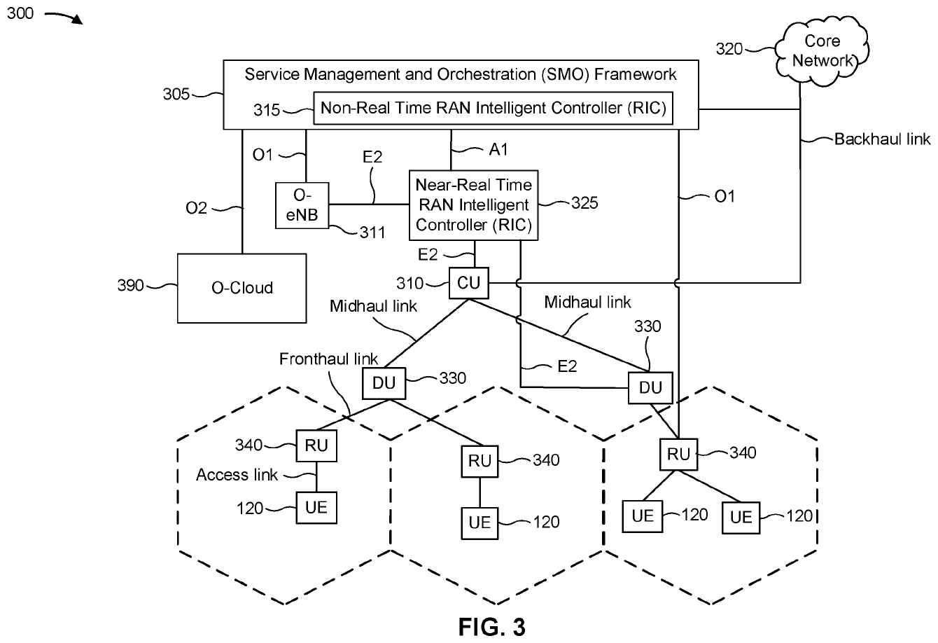

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an 02 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

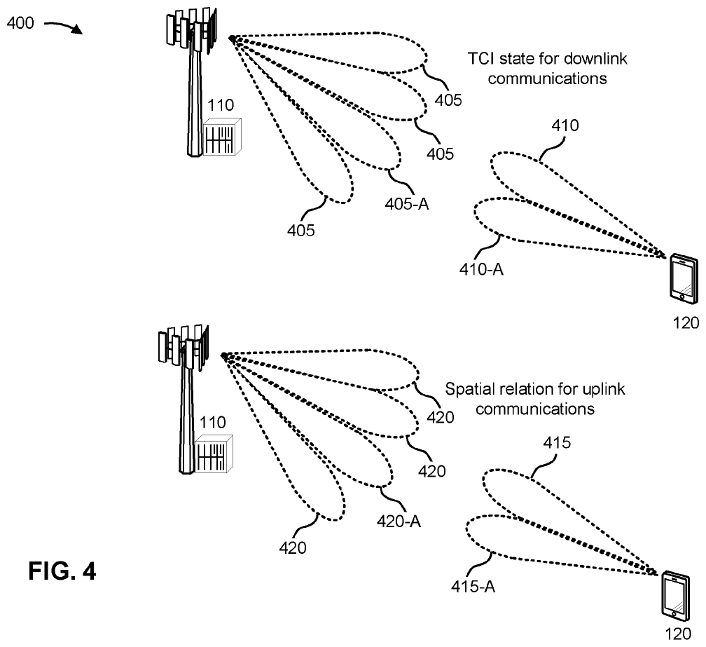

FIG. 4 is a diagram illustrating an example 400 of using beams for communications between a network node and a UE, in accordance with the present disclosure. As shown in FIG. 4, a network node 110 and a UE 120 may communicate with one another.

The network node 110 may transmit to UEs 120 located within a coverage area of the network node 110. The network node 110 and the UE 120 may be configured for beamformed communications, where the network node 110 may transmit in the direction of the UE 120 using a directional network node (NN) transmit beam (e.g., a BS transmit beam), and the UE 120 may receive the transmission using a directional UE receive beam. Each NN transmit beam may have an associated beam ID, beam direction, or beam symbols, among other examples. The network node 110 may transmit downlink communications via one or more NN transmit beams 405.

The UE 120 may attempt to receive downlink transmissions via one or more UE receive beams 410, which may be configured using different beamforming parameters at receive circuitry of the UE 120. The UE 120 may identify a particular NN transmit beam 405, shown as NN transmit beam 405-A, and a particular UE receive beam 410, shown as UE receive beam 410-A, that provide relatively favorable performance (for example, that have a best channel quality of the different measured combinations of NN transmit beams 405 and UE receive beams 410). In some examples, the UE 120 may transmit an indication of which NN transmit beam 405 is identified by the UE 120 as a preferred NN transmit beam, which the network node 110 may select for transmissions to the UE 120. The UE 120 may thus attain and maintain a beam pair link (BPL) with the network node 110 for downlink communications (for example, a combination of the NN transmit beam 405-A and the UE receive beam 410-A), which may be further refined and maintained in accordance with one or more established beam refinement procedures.

A downlink beam, such as an NN transmit beam 405 or a UE receive beam 410, may be associated with a TCI state. A TCI state may indicate a directionality or a characteristic of the downlink beam, such as one or more quasi-co-location (QCL) properties of the downlink beam. A QCL property may include, for example, a Doppler shift, a Doppler spread, an average delay, a delay spread, or spatial receive parameters, among other examples. In some examples, each NN transmit beam 405 may be associated with a synchronization signal block (SSB), and the UE 120 may indicate a preferred NN transmit beam 405 by transmitting uplink transmissions in resources of the SSB that are associated with the preferred NN transmit beam 405. A particular SSB may have an associated TCI state (for example, for an antenna port or for beamforming). The network node 110 may, in some examples, indicate a downlink NN transmit beam 405 based at least in part on antenna port QCL properties that may be indicated by the TCI state. A TCI state may be associated with one downlink reference signal set (for example, an SSB and an aperiodic, periodic, or semi-persistent channel state information reference signal (CSI-RS)) for different QCL types (for example, QCL types for different combinations of Doppler shift, Doppler spread, average delay, delay spread, or spatial receive parameters, among other examples). In cases where the QCL type indicates spatial receive parameters, the QCL type may correspond to analog receive beamforming parameters of a UE receive beam 410 at the UE 120. Thus, the UE 120 may select a corresponding UE receive beam 410 from a set of BPLs based at least in part on the network node 110 indicating an NN transmit beam 405 via a TCI indication.

The network node 110 may maintain a set of activated TCI states for downlink shared channel transmissions and a set of activated TCI states for downlink control channel transmissions. The set of activated TCI states for downlink shared channel transmissions may correspond to beams that the network node 110 uses for downlink transmission on a physical downlink shared channel (PDSCH). The set of activated TCI states for downlink control channel communications may correspond to beams that the network node 110 may use for downlink transmission on a physical downlink control channel (PDCCH) or in a control resource set (CORESET). The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (for example, activated PDSCH TCI states and activated CORESET TCI states) for the UE 120 may be configured by a configuration message, such as an RRC message.

Similarly, for uplink communications, the UE 120 may transmit in the direction of the network node 110 using a directional UE transmit beam, and the network node 110 may receive the transmission using a directional NN receive beam.

Each UE transmit beam may have an associated beam ID, beam direction, or beam symbols, among other examples. The UE 120 may transmit uplink communications via one or more UE transmit beams 415.

The network node 110 may receive uplink transmissions via one or more NN receive beams 420 (e.g., BS receive beams). The network node 110 may identify a particular UE transmit beam 415, shown as UE transmit beam 415-A, and a particular NN receive beam 420, shown as NN receive beam 420-A, that provide relatively favorable performance (for example, that have a best channel quality of the different measured combinations of UE transmit beams 415 and NN receive beams 420). In some examples, the network node 110 may transmit an indication of which UE transmit beam 415 is identified by the network node 110 as a preferred UE transmit beam, which the network node 110 may select for transmissions from the UE 120. The UE 120 and the network node 110 may thus attain and maintain a BPL for uplink communications (for example, a combination of the UE transmit beam 415-A and the NN receive beam 420-A), which may be further refined and maintained in accordance with one or more established beam refinement procedures. An uplink beam, such as a UE transmit beam 415 or an NN receive beam 420, may be associated with a spatial relation. A spatial relation may indicate a directionality or a characteristic of the uplink beam, similar to one or more QCL properties, as described above.

Additionally, or alternatively, as shown in FIG. 4, the network node 110 and the UE 120 may communicate using a unified TCI framework, in which case the network node 110 may indicate a TCI state that the UE 120 is to use for beamformed uplink communications. For example, in a unified TCI framework, a joint TCI state (which may be referred to as a joint downlink and uplink TCI state) may be used to indicate a common beam that the UE 120 is to use for downlink communication and uplink communication. In this case, the joint downlink and uplink TCI state may include at least one source reference signal to provide a reference (or UE assumption) for determining QCL properties for a downlink communication or a spatial filter for uplink communication. For example, the joint downlink and uplink TCI state may be associated with one or more source reference signals that provide common QCL information for UE-dedicated PDSCH reception and one or more CORESETs in a component carrier, or one or more source reference signals that provide a reference to determine one or more common uplink transmission spatial filters for a physical uplink shared channel (PUSCH) based on a dynamic grant or a configured grant or one or more dedicated physical uplink control channel (PUCCH) resources in a component carrier.

Additionally, or alternatively, the unified TCI framework may support a separate downlink (DL) TCI state and a separate uplink (UL) TCI state to accommodate separate downlink and uplink beam indications (e.g., in cases where a best uplink beam does not correspond to a best downlink beam, or vice versa). In such cases, each valid uplink TCI state configuration may contain a source reference signal to indicate an uplink transmit beam for a target uplink communication (e.g., a target uplink reference signal or a target uplink channel). For example, the source reference signal may be an sounding reference signal (SRS), an SSB, or a CSI-RS, among other examples, and the target uplink communication may be a PRACH, a PUCCH, a PUSCH, an SRS, and/or a DMRS (e.g., for a PUCCH or a PUSCH), among other examples. In this way, supporting joint TCI states or separate downlink and uplink TCI states may enable a unified TCI framework for downlink and uplink communications and/or may enable the network node 110 to indicate various uplink QCL relationships (e.g., Doppler shift, Doppler spread, average delay, or delay spread, among other examples) for uplink TCI communication.

During a random access procedure, a UE may transmit a random access message (RAM), which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The RAM may include a random access preamble identifier. A network node may transmit a random access response (RAR) as a reply to the preamble. The message that includes the RAR may be referred to as message 2, msg2, MSG2, or a second message in a four-step random access procedure. In some aspects, the RAR may indicate the detected random access preamble identifier (e.g., received from the UE in msg1). Additionally, or alternatively, the RAR may indicate a resource allocation to be used by the UE to transmit message 3 (msg3). In one example, the network node may transmit a PDCCH communication that schedules a PDSCH communication that includes the RAR. For example, the PDCCH communication may indicate a resource allocation for the PDSCH communication. Additionally, the PDSCH communication for the RAR, as scheduled by the PDCCH communication, may include a MAC protocol data unit (PDU).

To continue the random access procedure, the UE may transmit an RRC connection request message. The RRC connection request message may be referred to as message 3, msg3, MSG3, or a third message of a four-step random access procedure. In some aspects, the RRC connection request may include a UE identifier, uplink control information (UCI), and/or a PUSCH communication (e.g., an RRC connection request). In response, the network node may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, and/or contention resolution information. When the UE successfully receives the RRC connection setup message, the UE may transmit a hybrid automatic repeat request (HARQ) acknowledgement (ACK). When the UE fails to successfully receive the RRC connection setup message, the UE may retransmit msg3 to the network node.

During the random access procedure, latency is increased and processing resources and power are wasted when the UE and the network node are using different TCI states to transmit and receive random access messages. For example, when the UE uses a different beam to receive than the network node uses to transmit, quality and reliability of a downlink transmission to the UE are reduced. Similarly, when the UE uses a different beam to transmit than the UE uses to receive, quality and reliability of an uplink transmission to the network node are reduced. Reduced quality and reliability increases chances of retransmissions, which waste power and processing resources as well as increasing network congestion.

Some techniques and apparatuses described herein enable a UE (e.g., UE 120) to use rules to determine a TCI state to apply during random access procedure with a network entity (e.g., network node 110). For example, the UE 120 and the network node 110 may apply a unified TCI state, indicated by the network node 110, during a random access procedure. Alternatively, the UE 120 and the network node 110 may apply a same TCI state, other than the unified TCI state, during the random access procedure. By using the same beams to transmit and receive during the random access procedure, the UE 120 and the network node 110 experience increased quality and reliability of communications during the random access procedure. As a result, chances of retransmissions are reduced, which conserves power and processing resources as well as decreasing network congestion.

As indicated above, FIG. 4 is provided as an example. Other examples may differ from what is described with respect to FIG. 4.

FIG. 5 is a diagram illustrating an example 500 associated with refraining from using unified TCI states during a random access procedure, in accordance with the present disclosure. As shown in FIG. 5, a network node 110 (e.g., an RU 340 or a device controlling the RU 340, such as a DU 330 and/or a CU 310) and a UE 120 may communicate with one another (e.g., on a wireless network, such as wireless network 100 of FIG. 1).

As shown by reference number 505, the network node 110 may transmit (e.g., directly or via the RU 340), and the UE 120 may receive, an indication of a unified TCI state. For example, the indication may be included in DCI and/or a MAC control element (MAC-CE). When the unified TCI state is a DL TCI state, the UE 120 may apply the unified TCI state across multiple downlink channels (e.g., a PDCCH and a PDSCH). Similarly, when the unified TCI state is a UL TCI state, the UE 120 may apply the unified TCI state across multiple uplink channels (e.g., a PUCCH and a PUSCH). When the unified TCI state is a joint TCI state, the UE 120 may apply the unified TCI state across both downlink channels (e.g., a PDCCH and a PDSCH) and uplink channels (e.g., a PUCCH and a PUSCH).

As shown by reference number 510a, the UE 120 may apply a TCI state other than the unified TCI state in anticipation of performing a random access procedure with the network node 110. For example, the UE 120 may select a random access occasion for the random access procedure based on a reference signal, such as an SSB or a CSI-RS, broadcast by the network node 110 (e.g., directly or via the RU 340). Accordingly, the UE 120 may apply a QCL assumption using the reference signal.

Accordingly, as shown by reference number 510b, the network node 110 may also apply (e.g., directly or at the RU 340) the TCI state other than the unified TCI state when monitoring for a RAM. For example, the network node 110 may monitor random access occasions that are based on a reference signal, such as an SSB or a CSI-RS, broadcast by the network node 110 (e.g., directly or via the RU 340). Accordingly, the network node 110 may apply (e.g., directly or at the RU 340) a QCL assumption using the reference signal.

As shown by reference number 515, the UE 120 may transmit, and the network node 110 may receive (e.g., directly or via the RU 340), a random access preamble using the TCI state other than the unified TCI state. The random access preamble may be a sequence calculated based on the reference signal selected by the UE 120 for the random access procedure. As a result, the UE 120 may initiate the random access procedure by transmitting the random access preamble in a random access occasion.

As shown by reference number 520, the network node 110 may transmit (e.g., directly or via the RU 340), and the UE 120 may receive, a random access response using the TCI state other than the unified TCI state. For example, the random access response may include timing advance (TA) information for the UE 120 to apply during a remainder of the random access procedure. The random access response may be included in a PDSCH message.

In some aspects, the random access response is scheduled by DCI that is scrambled using a TC-RNTI. Accordingly, the network node 110 may transmit (e.g., directly or via the RU 340), and the UE 120 may receive, the DCI scrambled with the TC-RNTI, such that the random access response is scheduled by the DCI. The DCI may be transmitted and received within a random access response window associated with the reference signal selected by the UE 120 for the random access procedure. In some aspects, the DCI is included in a PDCCH message (associated with the random access procedure). Accordingly, the network node 110 may transmit (e.g., directly or via the RU 340), and the UE 120 may receive, the PDCCH message using the TCI state other than the unified TCI state.

As shown by reference number 525, the UE 120 may transmit, and the network node 110 may receive (e.g., directly or via the RU 340), msg3 for the random access procedure using the TCI state other than the unified TCI state. For example, msg3 may be included in a PUSCH message. Msg3 may be scheduled by the DCI that is scrambled using the TC-RNTI (e.g., as described above in connection with the random access response).

As shown by reference number 530, the network node 110 may transmit (e.g., directly or via the RU 340), and the UE 120 may receive, msg4 for the random access procedure using the TCI state other than the unified TCI state. For example, msg4 may establish an RRC connection between the network node 110 and the UE 120. Msg4 may be included in a PDSCH message.

In some aspects, msg4 is scheduled by additional DCI that is scrambled using the TC-RNTI. Accordingly, the network node 110 may transmit (e.g., directly or via the RU 340), and the UE 120 may receive, the additional DCI scrambled with the TC-RNTI, such that msg4 is scheduled by the additional DCI. The additional DCI may be transmitted and received within a common search space (CSS) associated with the reference signal selected by the UE 120 for the random access procedure. In some aspects, the additional DCI is included in a PDCCH message (associated with the random access procedure). Accordingly, the network node 110 may transmit (e.g., directly or via the RU 340), and the UE 120 may receive, the PDCCH message using the TCI state other than the unified TCI state.

As shown by reference number 535, the UE 120 may transmit, and the network node 110 may receive (e.g., directly or via the RU 340), HARQ feedback for msg4 using the TCI state other than the unified TCI state. For example, the UE 120 may transmit a HARQ ACK when msg4 was successfully received and decoded. On the other hand, the UE 120 may retransmit msg3 when the UE 120 fails to successfully receive and decode msg4. The UE 120 may use the TCI state other than the unified TCI state for any retransmissions of msg3.

By using techniques as described in connection with FIG. 5, the UE 120 and the network node 110 both apply the TCI state, other than the unified TCI state, during the random access procedure. By using the same beams to transmit and receive during the random access procedure, the UE 120 and the network node 110 experience increased quality and reliability of communications during the random access procedure. As a result, chances of retransmissions are reduced, which conserves power and processing resources as well as decreasing network congestion.

In some aspects, the UE 120 can be configured with a list of up to 128 DL or joint TCI (e.g., DLorJointTCIState) configurations, within the higher layer parameter PDSCH-Config (e.g., as defined in 3GPP specifications) for providing a reference signal for the quasi co-location for DM-RS of PDSCH and DM-RS of PDCCH other than PDSCH scheduled by DCI with cyclic redundancy check (CRC) scrambled by TC-RNTI in a component carrier (CC), for CSI-RS, and to provide a reference, if applicable, for determining UL transmit spatial filter for dynamic-grant and configured-grant based PUSCH other than PUSCH scheduled by DCI with CRC scrambled by TC-RNTI and PUCCH resource in a CC, and SRS.

As indicated above, FIG. 5 is provided as an example. Other examples may differ from what is described with respect to FIG. 5.

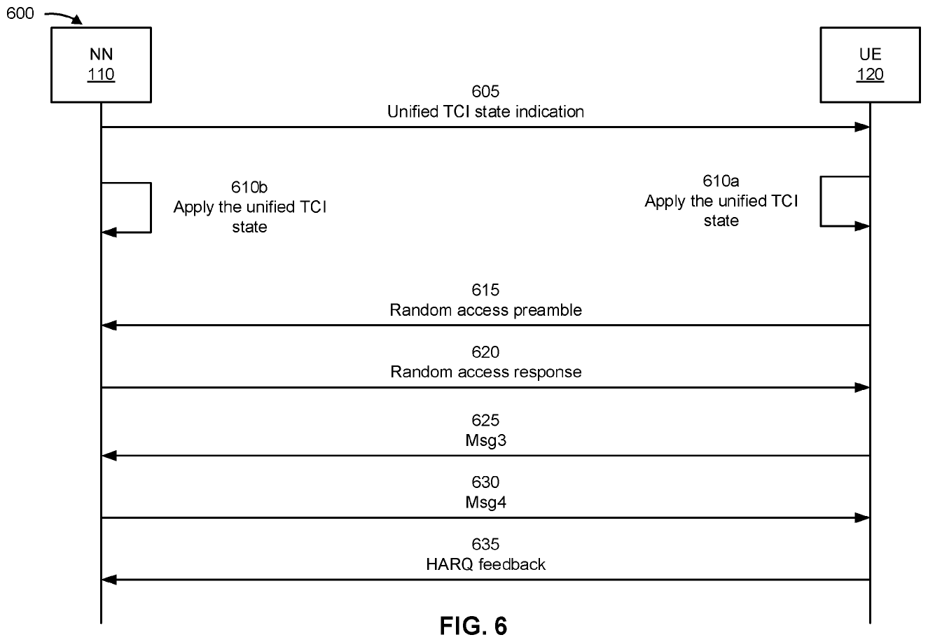

FIG. 6 is a diagram illustrating an example 600 associated with using unified TCI states during a random access procedure, in accordance with the present disclosure. As shown in FIG. 6, a network node 110 (e.g., an RU 340 or a device controlling the RU 340, such as a DU 330 and/or a CU 310) and a UE 120 may communicate with one another (e.g., on a wireless network, such as wireless network 100 of FIG. 1).

As shown by reference number 605, the network node 110 may transmit (e.g., directly or via the RU 340), and the UE 120 may receive, an indication of a unified TCI state. For example, the indication may be included in DCI and/or a MAC-CE. When the unified TCI state is a DL TCI state, the UE 120 may apply the unified TCI state across multiple downlink channels (e.g., a PDCCH and a PDSCH). Similarly, when the unified TCI state is a UL TCI state, the UE 120 may apply the unified TCI state across multiple uplink channels (e.g., a PUCCH and a PUSCH). When the unified TCI state is a joint TCI state, the UE 120 may apply the unified TCI state across both downlink channels (e.g., a PDCCH and a PDSCH) and uplink channels (e.g., a PUCCH and a PUSCH).

As shown by reference number 610a, the UE 120 may apply the unified TCI state in anticipation of performing a random access procedure with the network node 110. For example, the UE 120 may select a random access occasion for the random access procedure based on a reference signal, such as an SSB or a CSI-RS, broadcast by the network node 110 (e.g., directly or via the RU 340). The UE 120 may apply a QCL assumption indicated by the unified TCI state rather than using the reference signal.

Accordingly, as shown by reference number 610b, the network node 110 may also apply (e.g., directly or at the RU 340) the unified TCI state when monitoring for a RAM. For example, the network node 110 may monitor random access occasions that are based on a reference signal, such as an SSB or a CSI-RS, broadcast by the network node 110 (e.g., directly or via the RU 340). The network node 110 may apply (e.g., directly or at the RU 340) a QCL assumption indicated by the unified TCI state rather than using the reference signal.

As shown by reference number 615, the UE 120 may transmit, and the network node 110 may receive (e.g., directly or via the RU 340), a random access preamble using the unified TCI state. The random access preamble may be a sequence calculated based on the reference signal selected by the UE 120 for the random access procedure. As a result, the UE 120 may initiate the random access procedure by transmitting the random access preamble in a random access occasion.

As shown by reference number 620, the network node 110 may transmit (e.g., directly or via the RU 340), and the UE 120 may receive, a random access response using the unified TCI state. For example, the random access response may include TA information for the UE 120 to apply during a remainder of the random access procedure. The random access response may be included in a PDSCH message.

In some aspects, the random access response is scheduled by DCI that is scrambled using a TC-RNTI. Accordingly, the network node 110 may transmit (e.g., directly or via the RU 340), and the UE 120 may receive, the DCI scrambled with the TC-RNTI, such that the random access response is scheduled by the DCI. The DCI may be transmitted and received within a random access response window associated with the reference signal selected by the UE 120 for the random access procedure. In some aspects, the DCI is included in a PDCCH message (associated with the random access procedure). Accordingly, the network node 110 may transmit (e.g., directly or via the RU 340), and the UE 120 may receive, the PDCCH message using the unified TCI state.

As shown by reference number 625, the UE 120 may transmit, and the network node 110 may receive (e.g., directly or via the RU 340), msg3 for the random access procedure using the unified TCI state. For example, msg3 may be included in a PUSCH message. Msg3 may be scheduled by the DCI that is scrambled using the TC-RNTI (e.g., as described above in connection with the random access response).

As shown by reference number 630, the network node 110 may transmit (e.g., directly or via the RU 340), and the UE 120 may receive, msg4 for the random access procedure using the unified TCI state. For example, msg4 may establish an RRC connection between the network node 110 and the UE 120. Msg4 may be included in a PDSCH message.

In some aspects, msg4 is scheduled by additional DCI that is scrambled using the TC-RNTI. Accordingly, the network node 110 may transmit (e.g., directly or via the RU 340), and the UE 120 may receive, the additional DCI scrambled with the TC-RNTI, such that msg4 is scheduled by the additional DCI. The additional DCI may be transmitted and received within a CSS associated with the reference signal selected by the UE 120 for the random access procedure. In some aspects, the additional DCI is included in a PDCCH message (associated with the random access procedure).

Accordingly, the network node 110 may transmit (e.g., directly or via the RU 340), and the UE 120 may receive, the PDCCH message using the unified TCI state.

As shown by reference number 635, the UE 120 may transmit, and the network node 110 may receive (e.g., directly or via the RU 340), HARQ feedback for msg4 using the unified TCI state. For example, the UE 120 may transmit a HARQ ACK when msg4 was successfully received and decoded. On the other hand, the UE 120 may retransmit msg3 when the UE 120 fails to successfully receive and decode msg4. The UE 120 may use the unified TCI state for any retransmissions of msg3.

By using techniques as described in connection with FIG. 6, the UE 120 and the network node 110 both apply the unified TCI state during the random access procedure. By using the same beams to transmit and receive during the random access procedure, the UE 120 and the network node 110 experience increased quality and reliability of communications during the random access procedure. As a result, chances of retransmissions are reduced, which conserves power and processing resources as well as decreasing network congestion.

Example 600 may be combined with example 500. For example, the UE 120 and the network node 110 may use a TCI state other than the unified TCI state for some messages described in connection with FIGS. 5 and 6 (e.g., the random access preamble, the random access response, PDCCH messages associated with the random access procedure, downlink transmissions scheduled by DCI scrambled with the TC-RNTI, and/or uplink transmissions scheduled by DCI scrambled with the TC-RNTI) but use the unified TCI state for other messages described in connection with FIGS. 5 and 6. For example, using the unified TCI state for msg3 and HARQ feedback may be conditional on the unified TCI state being a UL TCI state or a joint TCI state such that a TCI state other than the unified TCI state is used when the unified TCI is not a UL TCI state or a joint TCI state. Similarly, using the unified TCI state for msg2 and msg4 may be conditional on the unified TCI state being a DL TCI state or a joint TCI state such that a TCI state other than the unified TCI state is used when the unified TCI is not a DL TCI state or a joint TCI state.

As indicated above, FIG. 6 is provided as an example. Other examples may differ from what is described with respect to FIG. 6.

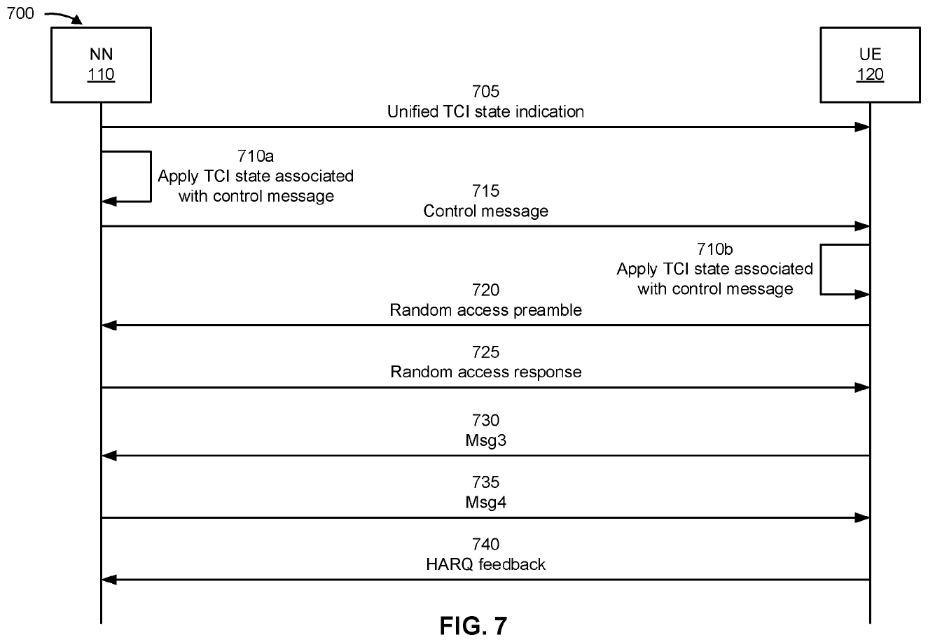

FIG. 7 is a diagram illustrating an example 700 associated with using a TCI state from a DCI order during a random access procedure, in accordance with the present disclosure. As shown in FIG. 7, a network node 110 (e.g., an RU 340 or a device controlling the RU 340, such as a DU 330 and/or a CU 310) and a UE 120 may communicate with one another (e.g., on a wireless network, such as wireless network 100 of FIG. 1).

As shown by reference number 705, the network node 110 may transmit (e.g., directly or via the RU 340), and the UE 120 may receive, an indication of a unified TCI state. For example, the indication may be included in DCI and/or a MAC-CE. When the unified TCI state is a DL TCI state, the UE 120 may apply the unified TCI state across multiple downlink channels (e.g., a PDCCH and a PDSCH). Similarly, when the unified TCI state is a UL TCI state, the UE 120 may apply the unified TCI state across multiple uplink channels (e.g., a PUCCH and a PUSCH). When the unified TCI state is a joint TCI state, the UE 120 may apply the unified TCI state across both downlink channels (e.g., a PDCCH and a PDSCH) and uplink channels (e.g., a PUCCH and a PUSCH).

As shown by reference number 710a, the network node 110 may apply (e.g., directly or at the RU 340) a TCI state for transmitting a control message to the UE 120. For example, the network node 110 may encode the control message to trigger the UE 120 to perform a random access procedure. The control message may include DCI (e.g., within a PDCCH message).

Accordingly, as shown by reference number 715, the network node 110 may transmit (e.g., directly or via the RU 340), and the UE 120 may receive, the control message. Therefore, the UE 120 will perform the random access procedure in response to the control message. As shown by reference number 710b, the UE 120 may apply the TCI state associated with the control message in anticipation of performing the random access procedure with the network node 110. For example, the UE 120 may select a random access occasion for the random access procedure based on a reference signal, such as an SSB or a CSI-RS, broadcast by the network node 110 (e.g., directly or via the RU 340) and indicated by the control message. The UE 120 may apply a QCL assumption indicated by the TCI state associated with the control message rather than using the reference signal. Similarly, the network node 110 may monitor random access occasions that are based on the reference signal, such as an SSB or a CSI-RS, broadcast by the network node 110 (e.g., directly or via the RU 340). The network node 110 may apply (e.g., directly or at the RU 340) a QCL assumption indicated by the un TCI state associated with the control message rather than using the reference signal.

As shown by reference number 720, the UE 120 may transmit, and the network node 110 may receive (e.g., directly or via the RU 340), a random access preamble using the TCI state associated with the control message. The random access preamble may be a sequence calculated based on the reference signal selected by the UE 120 for the random access procedure. As a result, the UE 120 may initiate the random access procedure by transmitting the random access preamble in a random access occasion.

As shown by reference number 725, the network node 110 may transmit (e.g., directly or via the RU 340), and the UE 120 may receive, a random access response using the TCI state associated with the control message. For example, the random access response may include TA information for the UE 120 to apply during a remainder of the random access procedure. The random access response may be included in a PDSCH message.

In some aspects, the random access response is scheduled by DCI that is scrambled using a TC-RNTI. Accordingly, the network node 110 may transmit (e.g., directly or via the RU 340), and the UE 120 may receive, the DCI scrambled with the TC-RNTI, such that the random access response is scheduled by the DCI. The DCI may be transmitted and received within a random access response window associated with the reference signal selected by the UE 120 for the random access procedure. In some aspects, the DCI is included in a PDCCH message (associated with the random access procedure). Accordingly, the network node 110 may transmit (e.g., directly or via the RU 340), and the UE 120 may receive, the PDCCH message using the TCI state associated with the control message.

As shown by reference number 730, the UE 120 may transmit, and the network node 110 may receive (e.g., directly or via the RU 340), msg3 for the random access procedure using the TCI state associated with the control message. For example, msg3 may be included in a PUSCH message. Msg3 may be scheduled by the DCI that is scrambled using the TC-RNTI (e.g., as described above in connection with the random access response).

As shown by reference number 735, the network node 110 may transmit (e.g., directly or via the RU 340), and the UE 120 may receive, msg4 for the random access procedure using the TCI state associated with the control message. For example, msg4 may establish an RRC connection between the network node 110 and the UE 120. Msg4 may be included in a PDSCH message.

In some aspects, msg4 is scheduled by additional DCI that is scrambled using the TC-RNTI. Accordingly, the network node 110 may transmit (e.g., directly or via the RU 340), and the UE 120 may receive, the additional DCI scrambled with the TC-RNTI, such that msg4 is scheduled by the additional DCI. The additional DCI may be transmitted and received within a CSS associated with the reference signal selected by the UE 120 for the random access procedure. In some aspects, the additional DCI is included in a PDCCH message (associated with the random access procedure). Accordingly, the network node 110 may transmit (e.g., directly or via the RU 340), and the UE 120 may receive, the PDCCH message using the TCI state associated with the control message.

As shown by reference number 740, the UE 120 may transmit, and the network node 110 may receive (e.g., directly or via the RU 340), HARQ feedback for msg4 using the TCI state associated with the control message. For example, the UE 120may transmit a HARQ ACK when msg4 was successfully received and decoded. On the other hand, the UE 120 may retransmit msg3 when the UE 120 fails to successfully receive and decode msg4. The UE 120 may use the TCI state associated with the control message for any retransmissions of msg3.

By using techniques as described in connection with FIG. 7, the UE 120 and the network node 110 both apply the TCI state associated with the control message during the random access procedure. By using the same beams to transmit and receive during the random access procedure, the UE 120 and the network node 110 experience increased quality and reliability of communications during the random access procedure. As a result, chances of retransmissions are reduced, which conserves power and processing resources as well as decreasing network congestion.

Example 700 may be combined with example 600 and/or example 500. For example, the UE 120 and the network node 110 may use the TCI state associated with the control message for some messages described in connection with FIGS. 5, 6, and 7 (e.g., the random access preamble, the random access response, PDCCH messages associated with the random access procedure, downlink transmissions scheduled by DCI scrambled with the TC-RNTI, and/or uplink transmissions scheduled by DCI scrambled with the TC-RNTI) but use the unified TCI state for other messages described in connection with FIGS. 6 and 7 and/or use a TCI state other than the unified TCI state for other messages described in connection with FIGS. 5 and 7. For example, using the unified TCI state for msg3 and HARQ feedback may be conditional on the unified TCI state being a UL TCI state or a joint TCI state such that a TCI state other than the unified TCI state is used when the unified TCI is not a UL TCI state or a joint TCI state. Similarly, using the unified TCI state for msg2 and msg4 may be conditional on the unified TCI state being a DL TCI state or a joint TCI state such that a TCI state other than the unified TCI state is used when the unified TCI is not a DL TCI state or a joint TCI state.

As indicated above, FIG. 7 is provided as an example. Other examples may differ from what is described with respect to FIG. 7.

FIG. 8 is a diagram illustrating an example process 800 performed, for example, by a mobile station, in accordance with the present disclosure. Example process 800 is an example where the mobile station (e.g., UE 120 and/or apparatus 1400 of FIG. 14) performs operations associated with refraining from applying unified TCI states for random access procedures.

As shown in FIG. 8, in some aspects, process 800 may include receiving an indication of a unified TCI state (block 810). For example, the mobile station (e.g., using communication manager 140 and/or reception component 1402, depicted in FIG. 14) may receive an indication of a unified TCI state, as described herein.

As further shown in FIG. 8, in some aspects, process 800 may include transmitting an uplink transmission, scheduled by DCI scrambled with a TC-RNTI, using a TCI state other than the unified TCI state (block 820). For example, the mobile station (e.g., using communication manager 140 and/or transmission component 1404, depicted in FIG. 14) may transmit an uplink transmission, scheduled by DCI scrambled with a TC-RNTI, using a TCI state other than the unified TCI state, as described herein.

Process 800 may include additional aspects, such as any single aspect or any combination of aspects described below and/or in connection with one or more other processes described elsewhere herein.

In a first aspect, the uplink transmission includes a PUSCH transmission associated with a random access procedure.

In a second aspect, alone or in combination with the first aspect, process 800 includes transmitting (e.g., using communication manager 140 and/or transmission component 1404), in a random access occasion, a random access preamble using a beam based at least in part on a reference signal associated with the random access occasion.

In a third aspect, alone or in combination with one or more of the first and second aspects, the reference signal includes an SSB or a CSI-RS.

In a fourth aspect, alone or in combination with one or more of the first through third aspects, process 800 includes receiving (e.g., using communication manager 140 and/or reception component 1402) a random access response using the TCI state other than the unified TCI state.

In a fifth aspect, alone or in combination with one or more of the first through fourth aspects, process 800 includes receiving (e.g., using communication manager 140 and/or reception component 1402) a PDCCH message, associated with a random access procedure, using the TCI state other than the unified TCI state.

In a sixth aspect, alone or in combination with one or more of the first through fifth aspects, process 800 includes receiving (e.g., using communication manager 140 and/or reception component 1402) a downlink message, scheduled by additional DCI scrambled with the TC-RNTI, using the TCI state other than the unified TCI state.

In a seventh aspect, alone or in combination with one or more of the first through sixth aspects, the downlink message includes a PDSCH message associated with a random access procedure.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network entity, in accordance with the present disclosure. Example process 900 is an example where the network entity (e.g., network node 110 and/or apparatus 1500 of FIG. 15) performs operations associated with refraining from applying unified TCI states for random access procedures.

As shown in FIG. 9, in some aspects, process 900 may include transmitting an indication of a unified TCI state (block 910). For example, the network entity (e.g., using communication manager 150 and/or transmission component 1504, depicted in FIG. 15) may transmit an indication of a unified TCI state, as described herein.

As further shown in FIG. 9, in some aspects, process 900 may include transmitting a downlink transmission, scheduled by DCI scrambled with a TC-RNTI, using a TCI state other than the unified TCI state (block 920). For example, the network entity (e.g., using communication manager 150 and/or transmission component 1504) may transmit a downlink transmission, scheduled by DCI scrambled with a TC-RNTI, using a TCI state other than the unified TCI state, as described herein.

Process 900 may include additional aspects, such as any single aspect or any combination of aspects described below and/or in connection with one or more other processes described elsewhere herein.

In a first aspect, the downlink transmission includes a PDSCH transmission associated with a random access procedure.

In a second aspect, alone or in combination with the first aspect, process 900 includes receiving (e.g., using communication manager 150 and/or reception component 1502, depicted in FIG. 15), in a random access occasion, a random access preamble using a beam based at least in part on a reference signal associated with the random access occasion.

In a third aspect, alone or in combination with one or more of the first and second aspects, the reference signal includes an SSB or a CSI-RS.

In a fourth aspect, alone or in combination with one or more of the first through third aspects, process 900 includes (e.g., using communication manager 150 and/or transmission component 1504) transmitting a random access response using the TCI state other than the unified TCI state.

In a fifth aspect, alone or in combination with one or more of the first through fourth aspects, process 900 includes transmitting (e.g., using communication manager 150 and/or transmission component 1504) a PDCCH message, associated with a random access procedure, using the TCI state other than the unified TCI state.

In a sixth aspect, alone or in combination with one or more of the first through fifth aspects, process 900 includes receiving (e.g., using communication manager 150 and/or reception component 1502) an uplink message, scheduled by additional DCI scrambled with the TC-RNTI, using the TCI state other than the unified TCI state.

In a seventh aspect, alone or in combination with one or more of the first through sixth aspects, the uplink message includes a PUSCH message associated with a random access procedure.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a mobile station, in accordance with the present disclosure. Example process 1000 is an example where the mobile station (e.g., UE 120 and/or apparatus 1400 of FIG. 14) performs operations associated with applying unified TCI states for random access procedures.

As shown in FIG. 10, in some aspects, process 1000 may include receiving an indication of a unified TCI state (block 1010). For example, the mobile station (e.g., using communication manager 140 and/or reception component 1402, depicted in FIG. 14) may receive an indication of a unified TCI state, as described herein.

As further shown in FIG. 10, in some aspects, process 1000 may include transmitting an uplink transmission, scheduled by DCI scrambled with a TC-RNTI, using the unified TCI state (block 1020). For example, the mobile station (e.g., using communication manager 140 and/or transmission component 1404, depicted in FIG. 14) may transmit an uplink transmission, scheduled by DCI scrambled with a TC-RNTI, using the unified TCI state, as described herein.

Process 1000 may include additional aspects, such as any single aspect or any combination of aspects described below and/or in connection with one or more other processes described elsewhere herein.

In a first aspect, the uplink transmission includes a PUSCH transmission associated with a random access procedure.

In a second aspect, alone or in combination with the first aspect, process 1000 includes transmitting (e.g., using communication manager 140 and/or transmission component 1404), in a random access occasion, a random access preamble using the unified TCI state.

In a third aspect, alone or in combination with one or more of the first and second aspects, process 1000 includes receiving (e.g., using communication manager 140 and/or reception component 1402) a random access response using the unified TCI state.

In a fourth aspect, alone or in combination with one or more of the first through third aspects, process 1000 includes receiving (e.g., using communication manager 140 and/or reception component 1402) a PDCCH message, associated with a random access procedure, using the unified TCI state.

In a fifth aspect, alone or in combination with one or more of the first through fourth aspects, process 1000 includes receiving (e.g., using communication manager 140 and/or reception component 1402) a downlink message, scheduled by additional DCI scrambled with the TC-RNTI, using the unified TCI state.

In a sixth aspect, alone or in combination with one or more of the first through fifth aspects, the downlink message includes a PDSCH message associated with a random access procedure.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network entity, in accordance with the present disclosure. Example process 1100 is an example where the network entity (e.g., network node 110 and/or apparatus 1500 of FIG. 15) performs operations associated with applying unified TCI states for random access procedures.

As shown in FIG. 11, in some aspects, process 1100 may include transmitting an indication of a unified TCI state (block 1110). For example, the network entity (e.g., using communication manager 150 and/or transmission component 1504, depicted in FIG. 15) may transmit an indication of a unified TCI state, as described herein.

As further shown in FIG. 11, in some aspects, process 1100 may include transmitting a downlink transmission, scheduled by DCI scrambled with a TC-RNTI, using the unified TCI state (block 1120). For example, the network entity (e.g., using communication manager 150 and/or transmission component 1504) may transmit a downlink transmission, scheduled by DCI scrambled with a TC-RNTI, using the unified TCI state, as described herein.

Process 1100 may include additional aspects, such as any single aspect or any combination of aspects described below and/or in connection with one or more other processes described elsewhere herein.

In a first aspect, the downlink transmission includes a PDSCH transmission associated with a random access procedure.

In a second aspect, alone or in combination with the first aspect, process 1100 includes receiving (e.g., using communication manager 150 and/or reception component 1502, depicted in FIG. 15), in a random access occasion, a random access preamble using the unified TCI state.

In a third aspect, alone or in combination with one or more of the first and second aspects, process 1100 includes transmitting (e.g., using communication manager 150 and/or transmission component 1504) a random access response using the unified TCI state.

In a fourth aspect, alone or in combination with one or more of the first through third aspects, process 1100 includes transmitting (e.g., using communication manager 150 and/or transmission component 1504) a PDCCH message, associated with a random access procedure, using the unified TCI state.

In a fifth aspect, alone or in combination with one or more of the first through fourth aspects, process 1100 includes receiving (e.g., using communication manager 150 and/or reception component 1502) an uplink message, scheduled by additional DCI scrambled with the TC-RNTI, using the unified TCI state.

In a sixth aspect, alone or in combination with one or more of the first through fifth aspects, the uplink message includes a PUSCH message associated with a random access procedure.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a mobile station, in accordance with the present disclosure. Example process 1200 is an example where the mobile station (e.g., UE 120 and/or apparatus 1400 of FIG. 14) performs operations associated with applying a TCI state from a PDCCH order for random access procedures.

As shown in FIG. 12, in some aspects, process 1200 may include receiving an indication of a unified TCI state (block 1210). For example, the mobile station (e.g., using communication manager 140 and/or reception component 1402, depicted in FIG. 14) may receive an indication of a unified TCI state, as described herein.

As further shown in FIG. 12, in some aspects, process 1200 may include receiving a control message triggering a random access procedure (block 1220). For example, the mobile station (e.g., using communication manager 140 and/or reception component 1402) may receive a control message triggering a random access procedure, as described herein.

As further shown in FIG. 12, in some aspects, process 1200 may include transmitting an uplink transmission, associated with the random access procedure, using a TCI state associated with the control message (block 1230). For example, the mobile station (e.g., using communication manager 140 and/or transmission component 1404, depicted in FIG. 14) may transmit an uplink transmission, associated with the random access procedure, using a TCI state associated with the control message, as described herein.

Process 1200 may include additional aspects, such as any single aspect or any combination of aspects described below and/or in connection with one or more other processes described elsewhere herein.

In a first aspect, the uplink transmission includes a PUSCH transmission associated with the random access procedure.

In a second aspect, alone or in combination with the first aspect, process 1200 includes receiving (e.g., using communication manager 140 and/or reception component 1402) a random access response using the TCI state associated with the control message.

In a third aspect, alone or in combination with one or more of the first and second aspects, process 1200 includes receiving (e.g., using communication manager 140 and/or reception component 1402) a PDCCH message, associated with the random access procedure, using the TCI state associated with the control message.

In a fourth aspect, alone or in combination with one or more of the first through third aspects, process 1200 includes receiving (e.g., using communication manager 140 and/or reception component 1402) a downlink message, scheduled by DCI scrambled with a TC-RNTI, using the TCI state associated with the control message.

In a fifth aspect, alone or in combination with one or more of the first through fourth aspects, the downlink message includes a PDSCH message associated with the random access procedure.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a network entity, in accordance with the present disclosure. Example process 1300 is an example where the network entity (e.g., network node 110 and/or apparatus 1500 of FIG. 15) performs operations associated with applying a TCI state from a PDCCH order for random access procedures.

As shown in FIG. 13, in some aspects, process 1300 may include transmitting an indication of a unified TCI state (block 1310). For example, the network entity (e.g., using communication manager 150 and/or transmission component 1504, depicted in FIG. 15) may transmit an indication of a unified TCI state, as described herein.

As further shown in FIG. 13, in some aspects, process 1300 may include transmitting a control message triggering a random access procedure (block 1320). For example, the network entity (e.g., using communication manager 150 and/or transmission component 1504) may transmit a control message triggering a random access procedure, as described herein.

As further shown in FIG. 13, in some aspects, process 1300 may include transmitting a downlink transmission, associated with the random access procedure, using a TCI state associated with the control message (block 1330). For example, the network entity (e.g., using communication manager 150 and/or transmission component 1504) may transmit a downlink transmission, associated with the random access procedure, using a TCI state associated with the control message, as described herein.

Process 1300 may include additional aspects, such as any single aspect or any combination of aspects described below and/or in connection with one or more other processes described elsewhere herein.

In a first aspect, the downlink transmission includes a PDSCH transmission associated with the random access procedure.

In a second aspect, alone or in combination with the first aspect, process 1300 includes transmitting (e.g., using communication manager 150 and/or transmission component 1504) a random access response using the TCI state associated with the control message.

In a third aspect, alone or in combination with one or more of the first and second aspects, process 1300 includes transmitting (e.g., using communication manager 150 and/or transmission component 1504) a PDCCH message, associated with the random access procedure, using the TCI state associated with the control message.

In a fourth aspect, alone or in combination with one or more of the first through third aspects, process 1300 includes receiving (e.g., using communication manager 150 and/or reception component 1502, depicted in FIG. 15) an uplink message, scheduled by DCI scrambled with a TC-RNTI, using the TCI state associated with the control message.

In a fifth aspect, alone or in combination with one or more of the first through fourth aspects, the uplink message includes a PUSCH message associated with the random access procedure.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication, in accordance with the present disclosure. The apparatus 1400 may be a mobile station, or a mobile station may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, an RU, or another wireless communication device) using the reception component 1402 and the transmission component 1404. As further shown, the apparatus 1400 may include the communication manager 140. The communication manager 140 may include a scheduling component 1408, among other examples.

In some aspects, the apparatus 1400 may be configured to perform one or more operations described herein in connection with FIGS. 5-7. Additionally, or alternatively, the apparatus 1400 may be configured to perform one or more processes described herein, such as process 800 of FIG. 8, process 1000 of FIG. 10, process 1200 of FIG. 12, or a combination thereof. In some aspects, the apparatus 1400 and/or one or more components shown in FIG. 14 may include one or more components of the UE described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the UE described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the UE described in connection with FIG. 2. In some aspects, the transmission component 1404 may be co-located with the reception component 1402 in a transceiver.

In some aspects, the reception component 1402 may receive (e.g., from the apparatus 1406, such as a network entity) an indication of a unified TCI state. Accordingly, the transmission component 1404 may transmit (e.g., to the apparatus 1406) an uplink transmission, scheduled by DCI scrambled with a TC-RNTI, using a TCI state other than the unified TCI state. Alternatively, the transmission component 1404 may transmit the uplink transmission, scheduled by the DCI scrambled with the TC-RNTI, using the unified TCI state.

For example, the reception component 1402 may receive the DCI scrambled with the TC-RNTI, and the scheduling component 1408 may schedule the transmission component 1404 to transmit the uplink transmission using resources indicated in the DCI. The scheduling component 1408 may include a modem, a modulator, a transmit MIMO processor, a transmit processor, a controller/processor, a memory, or a combination thereof, of the UE described in connection with FIG. 2.

In some aspects, the transmission component 1404 may transmit, in a random access occasion, a random access preamble using a beam based at least in part on a reference signal associated with the random access occasion. Alternatively, the transmission component 1404 may transmit, in the random access occasion, the random access preamble using the unified TCI state.

In some aspects, the reception component 1402 may receive a random access response using the TCI state other than the unified TCI state. Alternatively, the reception component 1402 may receive the random access response using the unified TCI state.

In some aspects, the reception component 1402 may receive a PDCCH message, associated with a random access procedure, using the TCI state other than the unified TCI state. Alternatively, the reception component 1402 may receive the PDCCH message, associated with the random access procedure, using the unified TCI state.

Accordingly, the reception component 1402 may receive a downlink message, scheduled by additional DCI scrambled with the TC-RNTI, using the TCI state other than the unified TCI state. Alternatively, the reception component 1402 may receive the downlink message, scheduled by the additional DCI scrambled with the TC-RNTI, using the unified TCI state. For example, the reception component 1402 may receive the additional DCI scrambled with the TC-RNTI, and the scheduling component 1408 may schedule the reception component 1402 to monitor for the downlink transmission using resources indicated in the DCI.

In some aspects, the reception component 1402 may further receive a control message triggering a random access procedure. Accordingly, the transmission component 1404 may transmit an uplink transmission, associated with the random access procedure, using a TCI state associated with the control message. Additionally, or alternatively, the reception component 1402 may receive a random access response using the TCI state associated with the control message. Additionally, or alternatively, the reception component 1402 may receive a PDCCH message, associated with the random access procedure, using the TCI state associated with the control message. Additionally, or alternatively, the reception component 1402 may receive a downlink message, scheduled by DCI scrambled with a TC-RNTI, using the TCI state associated with the control message. For example, the reception component 1402 may receive the DCI scrambled with the TC-RNTI, and the scheduling component 1408 may schedule the reception component 1402 to monitor for the downlink message using resources indicated in the DCI.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication, in accordance with the present disclosure. The apparatus 1500 may be a network entity, or a network entity may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, an RU, or another wireless communication device) using the reception component 1502 and the transmission component 1504. As further shown, the apparatus 1500 may include the communication manager 150. The communication manager 150 may include a scrambling component 1508, among other examples.

In some aspects, the apparatus 1500 may be configured to perform one or more operations described herein in connection with FIGS. 5-7. Additionally, or alternatively, the apparatus 1500 may be configured to perform one or more processes described herein, such as process 900 of FIG. 9, process 1100 of FIG. 11, process 1300 of FIG. 13, or a combination thereof. In some aspects, the apparatus 1500 and/or one or more components shown in FIG. 15 may include one or more components of the network node described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the network node described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the network node described in connection with FIG. 2. In some aspects, the transmission component 1504 may be co-located with the reception component 1502 in a transceiver.

In some aspects, the transmission component 1504 may transmit (e.g., to the apparatus 1506, such as a UE) an indication of a unified TCI state. Additionally, the transmission component 1504 may transmit (e.g., to the apparatus 1506) a downlink transmission, scheduled by DCI scrambled with a TC-RNTI, using a TCI state other than the unified TCI state. Alternatively, the transmission component 1504 may transmit the downlink transmission, scheduled by the DCI scrambled with the TC-RNTI, using the unified TCI state.

For example, the scrambling component 1508 may scramble the DCI using the TC-RNTI, and the transmission component 1504 may transmit the DCI to schedule the downlink transmission. The scrambling component 1508 may include a modem, a modulator, a transmit MIMO processor, a transmit processor, a controller/processor, a memory, or a combination thereof, of the UE described in connection with FIG. 2.

In some aspects, the reception component 1502 may receive, in a random access occasion, a random access preamble using a beam based at least in part on a reference signal associated with the random access occasion. Alternatively, the reception component 1502 may receive, in the random access occasion, the random access preamble using the unified TCI state.

In some aspects, the transmission component 1504 may transmit a random access response using the TCI state other than the unified TCI state. Alternatively, the transmission component 1504 may transmit the random access response using the unified TCI state.

In some aspects, the transmission component 1504 may transmit a PDCCH message, associated with a random access procedure, using the TCI state other than the unified TCI state. Alternatively, the transmission component 1504 may transmit the PDCCH message, associated with the random access procedure, using the unified TCI state.

In some aspects, the reception component 1502 may receive an uplink message, scheduled by additional DCI scrambled with the TC-RNTI, using the TCI state other than the unified TCI state. Alternatively, the reception component 1502 may receive the uplink message, scheduled by the additional DCI scrambled with the TC-RNTI, using the unified TCI state. For example, the scrambling component 1508 may scramble the additional DCI using the TC-RNTI, and the transmission component 1504 may transmit the additional DCI to schedule the uplink transmission.

In some aspects, the transmission component 1504 may further transmit a control message triggering a random access procedure. Accordingly, the transmission component 1504 may transmit a downlink transmission, associated with the random access procedure, using a TCI state associated with the control message. Additionally, or alternatively, the transmission component 1504 may transmit a random access response using the TCI state associated with the control message. Additionally, or alternatively, the transmission component 1504 may transmit a PDCCH message, associated with the random access procedure, using the TCI state associated with the control message. Additionally, or alternatively, the reception component 1502 may receive an uplink message, scheduled by DCI scrambled with a TC-RNTI, using the TCI state associated with the control message. For example, the scrambling component 1508 may scramble the DCI using the TC-RNTI, and the transmission component 1504 may transmit the DCI to schedule the uplink message.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a mobile station, comprising: receiving, by the mobile station, an indication of a unified transmission configuration indicator (TCI) state; and transmitting, by the mobile station, an uplink transmission, scheduled by downlink control information (DCI) scrambled with a temporary cell radio network temporary identifier (TC-RNTI), using a TCI state other than the unified TCI state.

Aspect 2: The method of Aspect 1, wherein the uplink transmission comprises a physical uplink shared channel (PUSCH) transmission associated with a random access procedure.

Aspect 3: The method of any of Aspects 1 through 2, further comprising: transmitting, in a random access occasion, a random access preamble using a beam based at least in part on a reference signal associated with the random access occasion.

Aspect 4: The method of Aspect 3, wherein the reference signal comprises a synchronization signal block (SSB) or a channel state information reference signal (CSI-RS).

Aspect 5: The method of any of Aspects 1 through 4, further comprising: receiving a random access response using the TCI state other than the unified TCI state.

Aspect 6: The method of any of Aspects 1 through 5, further comprising: receiving a physical downlink control channel (PDCCH) message, associated with a random access procedure, using the TCI state other than the unified TCI state.

Aspect 7: The method of any of Aspects 1 through 6, further comprising: receiving a downlink message, scheduled by additional DCI scrambled with the TC-RNTI, using the TCI state other than the unified TCI state.

Aspect 8: The method of Aspect 7, wherein the downlink message comprises a physical downlink shared channel (PDSCH) message associated with a random access procedure.

Aspect 9: A method of wireless communication performed by a network entity, comprising: transmitting, by the network entity, an indication of a unified transmission configuration indicator (TCI) state; and transmitting, by the network entity, a downlink transmission, scheduled by downlink control information (DCI) scrambled with a temporary cell radio network temporary identifier (TC-RNTI), using a TCI state other than the unified TCI state.

Aspect 10: The method of Aspect 9, wherein the downlink transmission comprises a physical downlink shared channel (PDSCH) transmission associated with a random access procedure.

Aspect 11: The method of any of Aspects 9 through 10, further comprising: receiving, in a random access occasion, a random access preamble using a beam based at least in part on a reference signal associated with the random access occasion.

Aspect 12: The method of Aspect 11, wherein the reference signal comprises a synchronization signal block (SSB) or a channel state information reference signal (CSI-RS).

Aspect 13: The method of any of Aspects 9 through 12, further comprising: transmitting a random access response using the TCI state other than the unified TCI state.

Aspect 14: The method of any of Aspects 9 through 13, further comprising: transmitting a physical downlink control channel (PDCCH) message, associated with a random access procedure, using the TCI state other than the unified TCI state.

Aspect 15: The method of any of Aspects 9 through 14, further comprising: receiving an uplink message, scheduled by additional DCI scrambled with the TC-RNTI, using the TCI state other than the unified TCI state.

Aspect 16: The method of Aspect 15, wherein the uplink message comprises a physical uplink shared channel (PUSCH) message associated with a random access procedure.

Aspect 17: A method of wireless communication performed by a mobile station, comprising: receiving, by the mobile station, an indication of a unified transmission configuration indicator (TCI) state; and transmitting, by the mobile station, an uplink transmission, scheduled by downlink control information (DCI) scrambled with a temporary cell radio network temporary identifier (TC-RNTI), using the unified TCI state.

Aspect 18: The method of Aspect 17, wherein the uplink transmission comprises a physical uplink shared channel (PUSCH) transmission associated with a random access procedure.

Aspect 19: The method of any of Aspects 17 through 18, further comprising: transmitting, in a random access occasion, a random access preamble using the unified TCI state.

Aspect 20: The method of any of Aspects 17 through 19, further comprising: receiving a random access response using the unified TCI state.

Aspect 21: The method of any of Aspects 17 through 20, further comprising: receiving a physical downlink control channel (PDCCH) message, associated with a random access procedure, using the unified TCI state.

Aspect 22: The method of any of Aspects 17 through 21, further comprising: receiving a downlink message, scheduled by additional DCI scrambled with the TC-RNTI, using the unified TCI state.

Aspect 23: The method of Aspect 22, wherein the downlink message comprises a physical downlink shared channel (PDSCH) message associated with a random access procedure.

Aspect 24: A method of wireless communication performed by a network entity, comprising: transmitting, by the network entity, an indication of a unified transmission configuration indicator (TCI) state; and transmitting, by the network entity, a downlink transmission, scheduled by downlink control information (DCI) scrambled with a temporary cell radio network temporary identifier (TC-RNTI), using the unified TCI state.

Aspect 25: The method of Aspect 24, wherein the downlink transmission comprises a physical downlink shared channel (PDSCH) transmission associated with a random access procedure.

Aspect 26: The method of any of Aspects 24 through 25, further comprising: receiving, in a random access occasion, a random access preamble using the unified TCI state.

Aspect 27: The method of any of Aspects 24 through 26, further comprising: transmitting a random access response using the unified TCI state.

Aspect 28: The method of any of Aspects 24 through 27, further comprising: transmitting a physical downlink control channel (PDCCH) message, associated with a random access procedure, using the unified TCI state.

Aspect 29: The method of any of Aspects 24 through 28, further comprising: receiving an uplink message, scheduled by additional DCI scrambled with the TC-RNTI, using the unified TCI state.

Aspect 30: The method of Aspect 29, wherein the uplink message comprises a physical uplink shared channel (PUSCH) message associated with a random access procedure.

Aspect 31: A method of wireless communication performed by a mobile station, comprising: receiving, by the mobile station, an indication of a unified transmission configuration indicator (TCI) state; receiving, by the mobile station, a control message triggering a random access procedure; and transmitting, by the mobile station, an uplink transmission, associated with the random access procedure, using a TCI state associated with the control message.

Aspect 32: The method of Aspect 31, wherein the uplink transmission comprises a physical uplink shared channel (PUSCH) transmission associated with the random access procedure.

Aspect 33: The method of any of Aspects 31 through 32, further comprising: receiving a random access response using the TCI state associated with the control message.

Aspect 34: The method of any of Aspects 31 through 33, further comprising: receiving a physical downlink control channel (PDCCH) message, associated with the random access procedure, using the TCI state associated with the control message.

Aspect 35: The method of any of Aspects 31 through 34, further comprising: receiving a downlink message, scheduled by downlink control information (DCI) scrambled with a temporary cell radio network temporary identifier (TC-RNTI), using the TCI state associated with the control message.

Aspect 36: The method of Aspect 35, wherein the downlink message comprises a physical downlink shared channel (PDSCH) message associated with the random access procedure.

Aspect 37: A method of wireless communication performed by a network entity, comprising: transmitting, by the network entity, an indication of a unified transmission configuration indicator (TCI) state; transmitting, by the network entity, a control message triggering a random access procedure; and transmitting, by the network entity, a downlink transmission, associated with the random access procedure, using a TCI state associated with the control message.

Aspect 38: The method of Aspect 37, wherein the downlink transmission comprises a physical downlink shared channel (PDSCH) transmission associated with the random access procedure.

Aspect 39: The method of any of Aspects 37 through 38, further comprising: transmitting a random access response using the TCI state associated with the control message.

Aspect 40: The method of any of Aspects 37 through 39, further comprising: transmitting a physical downlink control channel (PDCCH) message, associated with the random access procedure, using the TCI state associated with the control message.

Aspect 41: The method of any of Aspects 37 through 40, further comprising: receiving an uplink message, scheduled by downlink control information (DCI) scrambled with a temporary cell radio network temporary identifier (TC-RNTI), using the TCI state associated with the control message.

Aspect 42: The method of Aspect 41, wherein the uplink message comprises a physical uplink shared channel (PUSCH) message associated with the random access procedure.

Aspect 43: An apparatus for wireless communication at a device, comprising a processor; memory coupled with the processor; and instructions stored in the memory and executable by the processor to cause the apparatus to perform the method of one or more of Aspects 1-8.

Aspect 44: A device for wireless communication, comprising a memory and one or more processors coupled to the memory, the one or more processors configured to perform the method of one or more of Aspects 1-8.

Aspect 45: An apparatus for wireless communication, comprising at least one means for performing the method of one or more of Aspects 1-8.

Aspect 46: A non-transitory computer-readable medium storing code for wireless communication, the code comprising instructions executable by a processor to perform the method of one or more of Aspects 1-8.

Aspect 47: A non-transitory computer-readable medium storing a set of instructions for wireless communication, the set of instructions comprising one or more instructions that, when executed by one or more processors of a device, cause the device to perform the method of one or more of Aspects 1-8.

Aspect 48: An apparatus for wireless communication at a device, comprising a processor; memory coupled with the processor; and instructions stored in the memory and executable by the processor to cause the apparatus to perform the method of one or more of Aspects 9-16.

Aspect 49: A device for wireless communication, comprising a memory and one or more processors coupled to the memory, the one or more processors configured to perform the method of one or more of Aspects 9-16.

Aspect 50: An apparatus for wireless communication, comprising at least one means for performing the method of one or more of Aspects 9-16.

Aspect 51: A non-transitory computer-readable medium storing code for wireless communication, the code comprising instructions executable by a processor to perform the method of one or more of Aspects 9-16.

Aspect 52: A non-transitory computer-readable medium storing a set of instructions for wireless communication, the set of instructions comprising one or more instructions that, when executed by one or more processors of a device, cause the device to perform the method of one or more of Aspects 9-16.

Aspect 53: An apparatus for wireless communication at a device, comprising a processor; memory coupled with the processor; and instructions stored in the memory and executable by the processor to cause the apparatus to perform the method of one or more of Aspects 17-23.

Aspect 54: A device for wireless communication, comprising a memory and one or more processors coupled to the memory, the one or more processors configured to perform the method of one or more of Aspects 17-23.

Aspect 55: An apparatus for wireless communication, comprising at least one means for performing the method of one or more of Aspects 17-23.

Aspect 56: A non-transitory computer-readable medium storing code for wireless communication, the code comprising instructions executable by a processor to perform the method of one or more of Aspects 17-23.

Aspect 57: A non-transitory computer-readable medium storing a set of instructions for wireless communication, the set of instructions comprising one or more instructions that, when executed by one or more processors of a device, cause the device to perform the method of one or more of Aspects 17-23.

Aspect 58: An apparatus for wireless communication at a device, comprising a processor; memory coupled with the processor; and instructions stored in the memory and executable by the processor to cause the apparatus to perform the method of one or more of Aspects 24-30.

Aspect 59: A device for wireless communication, comprising a memory and one or more processors coupled to the memory, the one or more processors configured to perform the method of one or more of Aspects 24-30.

Aspect 60: An apparatus for wireless communication, comprising at least one means for performing the method of one or more of Aspects 24-30.

Aspect 61: A non-transitory computer-readable medium storing code for wireless communication, the code comprising instructions executable by a processor to perform the method of one or more of Aspects 24-30.

Aspect 62: A non-transitory computer-readable medium storing a set of instructions for wireless communication, the set of instructions comprising one or more instructions that, when executed by one or more processors of a device, cause the device to perform the method of one or more of Aspects 24-30.

Aspect 63: An apparatus for wireless communication at a device, comprising a processor; memory coupled with the processor; and instructions stored in the memory and executable by the processor to cause the apparatus to perform the method of one or more of Aspects 31-36.

Aspect 64: A device for wireless communication, comprising a memory and one or more processors coupled to the memory, the one or more processors configured to perform the method of one or more of Aspects 31-36.

Aspect 65: An apparatus for wireless communication, comprising at least one means for performing the method of one or more of Aspects 31-36.

Aspect 66: A non-transitory computer-readable medium storing code for wireless communication, the code comprising instructions executable by a processor to perform the method of one or more of Aspects 31-36.

Aspect 67: A non-transitory computer-readable medium storing a set of instructions for wireless communication, the set of instructions comprising one or more instructions that, when executed by one or more processors of a device, cause the device to perform the method of one or more of Aspects 31-36.

Aspect 68: An apparatus for wireless communication at a device, comprising a processor; memory coupled with the processor; and instructions stored in the memory and executable by the processor to cause the apparatus to perform the method of one or more of Aspects 37-42.

Aspect 69: A device for wireless communication, comprising a memory and one or more processors coupled to the memory, the one or more processors configured to perform the method of one or more of Aspects 37-42.

Aspect 70: An apparatus for wireless communication, comprising at least one means for performing the method of one or more of Aspects 37-42.

Aspect 71: A non-transitory computer-readable medium storing code for wireless communication, the code comprising instructions executable by a processor to perform the method of one or more of Aspects 37-42.

Aspect 72: A non-transitory computer-readable medium storing a set of instructions for wireless communication, the set of instructions comprising one or more instructions that, when executed by one or more processors of a device, cause the device to perform the method of one or more of Aspects 37-42.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a mobile station, comprising:
a memory; and
one or more processors, coupled to the memory and based at least in part on information stored in the memory, configured to:
receive an indication of a unified transmission configuration indicator (TCI) state; and
transmit an uplink transmission, scheduled by downlink control information (DCI) scrambled with a temporary cell radio network temporary identifier (TC-RNTI), using a TCI state other than the unified TCI state.

2. The apparatus of claim 1, wherein the uplink transmission comprises a physical uplink shared channel (PUSCH) transmission associated with a random access procedure.

3. The apparatus of claim 1, wherein the one or more processors are further configured to:
transmit, in a random access occasion, a random access preamble using a beam based at least in part on a reference signal associated with the random access occasion.

4. The apparatus of claim 3, wherein the reference signal comprises a synchronization signal block (SSB) or a channel state information reference signal (CSI-RS).

5. The apparatus of claim 1, wherein the one or more processors are further configured to:
receive a random access response using the TCI state other than the unified TCI state.

6. The apparatus of claim 1, wherein the one or more processors are further configured to:
receive a physical downlink control channel (PDCCH) message, associated with a random access procedure, using the TCI state other than the unified TCI state.

7. The apparatus of claim 1, wherein the one or more processors are further configured to:
receive a downlink message, scheduled by additional DCI scrambled with the TC-RNTI, using the TCI state other than the unified TCI state.

8. The apparatus of claim 7, wherein the downlink message comprises a physical downlink shared channel (PDSCH) message associated with a random access procedure.

9. An apparatus for wireless communication at a network entity, comprising:
a memory; and
one or more processors, coupled to the memory and based at least in part on information stored in the memory, configured to:
transmit an indication of a unified transmission configuration indicator (TCI) state; and
transmit a downlink transmission, scheduled by downlink control information (DCI) scrambled with a temporary cell radio network temporary identifier (TC-RNTI), using a TCI state other than the unified TCI state.

10. The apparatus of claim 9, wherein the downlink transmission comprises a physical downlink shared channel (PDSCH) transmission associated with a random access procedure.

11. The apparatus of claim 9, wherein the one or more processors are further configured to:
receive, in a random access occasion, a random access preamble using a beam based at least in part on a reference signal associated with the random access occasion.

12. The apparatus of claim 11, wherein the reference signal comprises a synchronization signal block (SSB) or a channel state information reference signal (CSI-RS).

13. The apparatus of claim 9, wherein the one or more processors are further configured to:
transmit a random access response using the TCI state other than the unified TCI state.

14. The apparatus of claim 9, wherein the one or more processors are further configured to:
transmit a physical downlink control channel (PDCCH) message, associated with a random access procedure, using the TCI state other than the unified TCI state.

15. The apparatus of claim 9, wherein the one or more processors are further configured to:
receive an uplink message, scheduled by additional DCI scrambled with the TC-RNTI, using the TCI state other than the unified TCI state.

16. The apparatus of claim 15, wherein the uplink message comprises a physical uplink shared channel (PUSCH) message associated with a random access procedure.

17. An apparatus for wireless communication at a mobile station, comprising:
a memory; and
one or more processors, coupled to the memory and based at least in part on information stored in the memory, configured to:
receive an indication of a unified transmission configuration indicator (TCI) state; and
transmit an uplink transmission, scheduled by downlink control information (DCI) scrambled with a temporary cell radio network temporary identifier (TC-RNTI), using the unified TCI state.

18. The apparatus of claim 17, wherein the uplink transmission comprises a physical uplink shared channel (PUSCH) transmission associated with a random access procedure.

19. The apparatus of claim 17, wherein the one or more processors are further configured to:
transmit, in a random access occasion, a random access preamble using the unified TCI state.

20. The apparatus of claim 17, wherein the one or more processors are further configured to:
receive a random access response using the unified TCI state.

21. The apparatus of claim 17, wherein the one or more processors are further configured to:
receive a physical downlink control channel (PDCCH) message, associated with a random access procedure, using the unified TCI state.

22. The apparatus of claim 17, wherein the one or more processors are further configured to:
receive a downlink message, scheduled by additional DCI scrambled with the TC-RNTI, using the unified TCI state.

23. The apparatus of claim 22, wherein the downlink message comprises a physical downlink shared channel (PDSCH) message associated with a random access procedure.

24. An apparatus for wireless communication at a network entity, comprising:
a memory; and
one or more processors, coupled to the memory and based at least in part on information stored in the memory, configured to:
transmit an indication of a unified transmission configuration indicator (TCI) state; and
transmit a downlink transmission, scheduled by downlink control information (DCI) scrambled with a temporary cell radio network temporary identifier (TC-RNTI), using the unified TCI state.

25. The apparatus of claim 24, wherein the downlink transmission comprises a physical downlink shared channel (PDSCH) transmission associated with a random access procedure.

26. The apparatus of claim 24, wherein the one or more processors are further configured to:
receive, in a random access occasion, a random access preamble using the unified TCI state.

27. The apparatus of claim 24, wherein the one or more processors are further configured to:
transmit a random access response using the unified TCI state.

28. The apparatus of claim 24, wherein the one or more processors are further configured to:
transmit a physical downlink control channel (PDCCH) message, associated with a random access procedure, using the unified TCI state.

29. The apparatus of claim 24, wherein the one or more processors are further configured to:
receive an uplink message, scheduled by additional DCI scrambled with the TC-RNTI, using the unified TCI state.

30. The apparatus of claim 29, wherein the uplink message comprises a physical uplink shared channel (PUSCH) message associated with a random access procedure.
